(19) United States
(12) Patent Application Publication
(10) Pub. No.: US 2025/0253908 A1
(43) Pub. Date: Aug. 7, 2025

(54) METHODS AND APPARATUS FOR HIGH DOPPLER TYPE-II CSI MEASUREMENT AND REPORTING

(71) Applicant: InterDigital Patent Holdings, Inc., Wilmington, DE (US)

(72) Inventors: Mohammad Irfan, Chateauguay (CA); Afshin Haghighat, Ile-Bizard (CA); Jonghyun Park, Syosset, NY (US); Loic Canonne-Velasquez, Dorval (CA); Moon-il Lee, Melville, NY (US)

(73) Assignee: InterDigital Patent Holdings, Inc., Wilmington, DE (US)

(21) Appl. No.: 18/856,781

(22) PCT Filed: Apr. 21, 2023
(86) PCT No.: PCT/US23/19399

§ 371 Date: Oct. 14, 2024

Related U.S. Application Data
(60) Provisional application No. 63/335,087, filed on Apr. 26, 2022.
(60) Provisional application No. 63/396,042, filed on Aug. 8, 2022.
(60) Provisional application No. 63/444,744, filed on Feb. 10, 2023.

(51) Int. Cl. H04B 7/06; H04W 24/10

(52) U.S. Cl. CPC H04B 7/0626; H04B 7/0639; H04W 24/10

(57) ABSTRACT

A method performed by a WTRU includes receiving channel state information (CSI) reporting configuration information indicating a plurality of matrices, a total number of rows and columns for each of the matrices, and an indication to report on non-zero coefficients (NZCs) and, receiving CSI reference signals (CSI-RS). The method determines a precoding matrix indicator (PMI) based on channel measurements associated with the CSI-RS, wherein the PMI includes, for each matrix an indication of a total number of NZCs per column for all columns having NZCs in at least one row and in less than all rows of the matrix, and an indication of a row index for each column of each of the columns having NZCs in at least one row and in less than all rows of the matrix. The method includes reporting the PMI to a network entity.

### CROSS REFERENCE TO RELATED APPLICATIONS

This application claims the benefit of US Provisional Patent Application Nos. 63/335,087, filed 26 Apr. 2022, 63/396,042, filed 8 Aug. 2022, and 63/444,744 filed 10 Feb. 2023, which are incorporated by reference herein in their entirety.

### FIELD

This disclosure pertains to methods and apparatus for high Doppler Type-II channel state information (CSI) measurement and reporting.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. TA according to an embodiment;

FIG. 2 is a graphical illustration depicting a high-level demonstration of channel state information (CSI) measurement and reporting in high Doppler;

FIG. 3 depicts a single component precoder used with reference to aspects of the disclosure;

FIG. 4 depicts multiple component precoders used with reference to aspects of the disclosure;

FIG. 5 depicts an example reporting procedure incorporating methods of reporting non-zero coefficients or zero coefficients according to aspects of the disclosure;

FIG. 6 depicts a method of reporting non-zero coefficients in multiple precoders according to aspects of the disclosure;

FIG. 7 depicts another method of reporting non-zero coefficients in multiple precoders according to aspects of the disclosure;

FIG. 8 depicts an example flow diagram of a method described in FIG. 6; and

FIG. 9 depicts an example flow diagram of a method described in FIG. 7.

### DETAILED DESCRIPTION

### Introduction

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

### Example Communication System

FIG. TA is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. TA, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

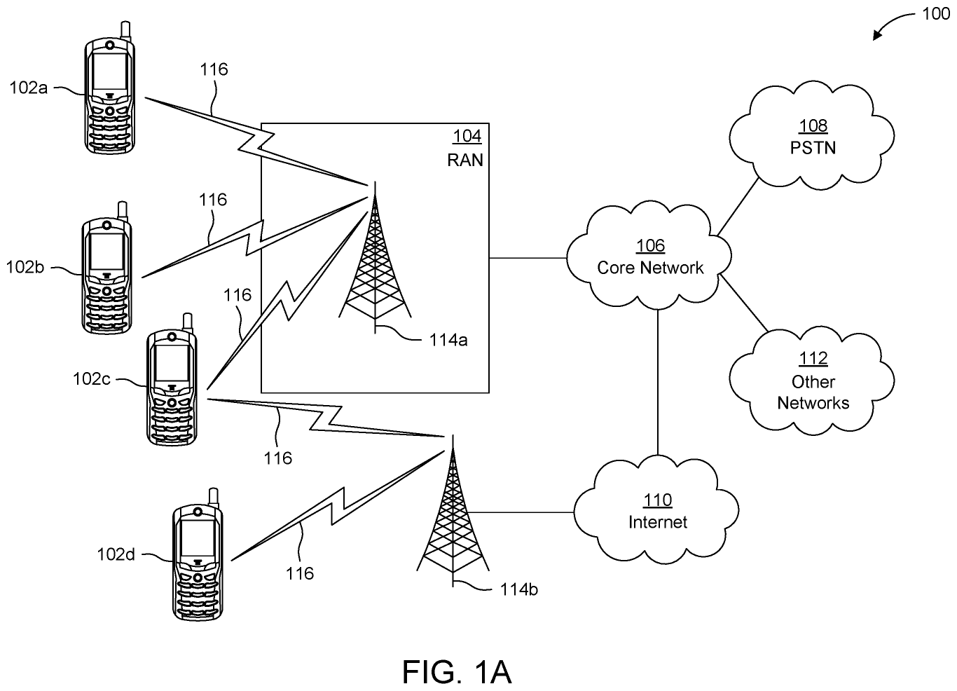

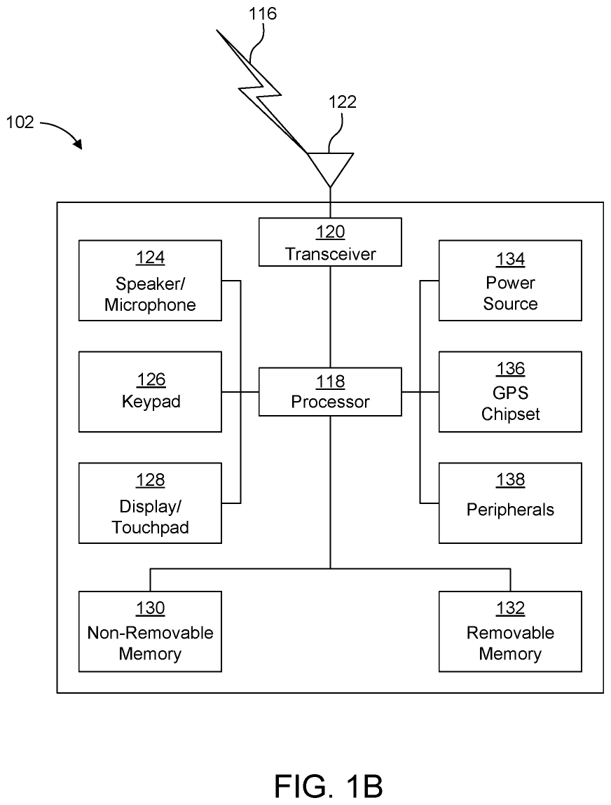

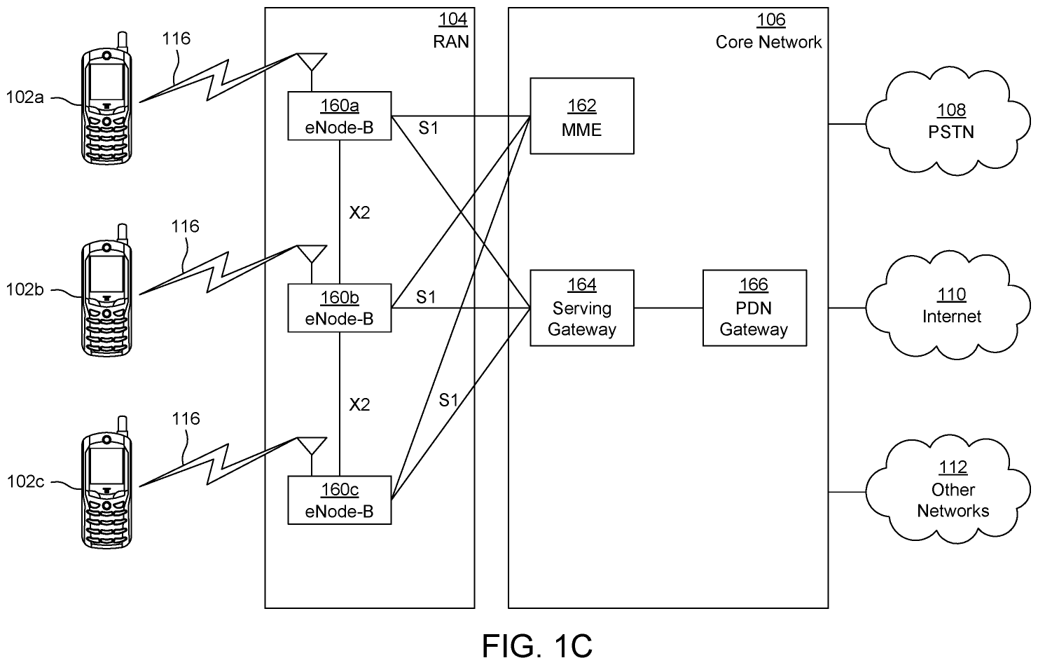

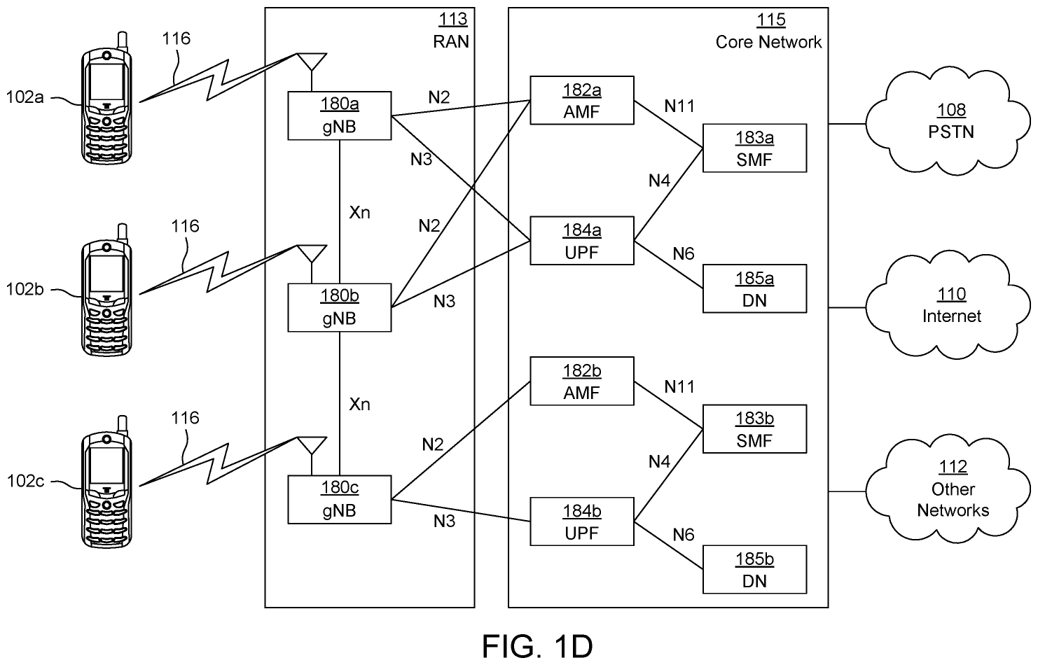

The base station 114b in FIG. 1A may be a wireless router, Home Node B, Home eNode B. or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. TA, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. TA may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.1 lac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b. 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-ID, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Examples provided herein do not limit applicability of the subject matter to other wireless technologies, e.g., using the same or different principles as may be applicable.

As explained herein, a wireless transmit/receive unit (WTRU) may be an example of a user equipment (UE). Hence the terms UE and WTRU may be used with equal scope herein.

### Measurement and Reporting in Legacy Systems

Multiple-input multiple-output (MIMO) techniques can enhance capacity, throughput, reliability, and coverage. Accurate channel state information (CSI) is essential to ensure the gains of MIMO. However, accurate CSI acquisition for MIMO is a tedious and resource hungry task. The process of acquiring CSI becomes even more difficult and resource hungry when a WTRU moves with a higher velocity.

3GPP Release15 (Rel. 15) supports a dual-stage codebook structure, represented as W=W₁W₂, where W₁ captures the long-term wideband statistics of the channel and W₂ captures the fast-fading properties of the channel. The W₂ matrix contains subband amplitude coefficients and phase coefficients for co-phasing different beams. In Rel. 15, each of the wideband amplitude coefficients in W₁ is quantized with 3 bits and each subband amplitude coefficient in W₂ is quantized with 1 bit. The phase combining coefficients in W₂ are taken from a Quadrature phase shift keying (QPSK) or 8PSK. In Rel. 16/17, the W₂ matrix is transformed using a discrete Fourier transform (DFT) matrix to make it sparse. Such a transformation drastically reduces the feedback overhead as compared to Rel. 15. The DFT transformation of W₂ in Rel. 16/17 leading to feedback reduction allow quantization of the subband amplitude and phase coefficients with more bits. Particularly, in Rel. 16/17, the subband amplitude and phase coefficients are quantized with 3 and 4 bits, respectively.

The Rel. 15, Rel. 16/17 codebooks do not consider Doppler or its effect on performance. MIMO CSI correction in the presence of high Doppler is not supported in Rel. 16/17. Therefore, Rel. 18 aims to enhance CSI reporting under medium and high WTRU velocities by exploiting time-domain correlation and to exploit Doppler-domain information to assist downlink (DL) precoding in frequency range 1 (FRI). The objective of Rel. 18 is to refine the Rel.17 Type-II codebook without any modification to its spatial and frequency domain basis. It also aims to enhance reporting of the time-domain channel properties measured via CSI reference signal (RS) CSI-RS for tracking.

### Issues Addressed by Embodiments Disclosed Herein

At high WTRU velocity, the wireless channel changes abruptly and the existing MIMO CSI-RS transmission and CSI reporting will fail to deliver reasonable performance. One naive strategy to enhance performance is to allocate heavy resources both in downlink and uplink to handle the large amount of feedback. At high WTRU velocity, long-term channel statics of the wireless channel changes slowly in time as compared to the channel gains. Considering channel aging, a set of other implementations can be developed by exploiting the long-term channel statistics. Several implementations in terms of CSI reporting can also be developed. A set of implementations are provided in the following section.

### Embodiments Disclosed Herein

Discussed herein are procedures for capturing CSI in the presence of medium to high Doppler, procedures for reporting different time-domain elements of a CSI report, and procedures for prioritizing different time-domain elements of a CSI report.

### Procedures for CSI-RS Measurement in the Presence of Doppler

In NR Rel-17, the Type II CSI framework is based on multiple sub-functionalities that encompass wideband and narrow band CSI, beam combining, co-phasing, and frequency compression. The Rel-17 framework essentially relies on instantaneous CSI and assumes that the wireless channel does not experience a significant change between CSI measurement instances. Such assumption may hold true if CSI measurement instances are high enough to keep up with the changes in the channel, however CSI measurement and reporting at high rates result in a very high and prohibitive signaling overhead.

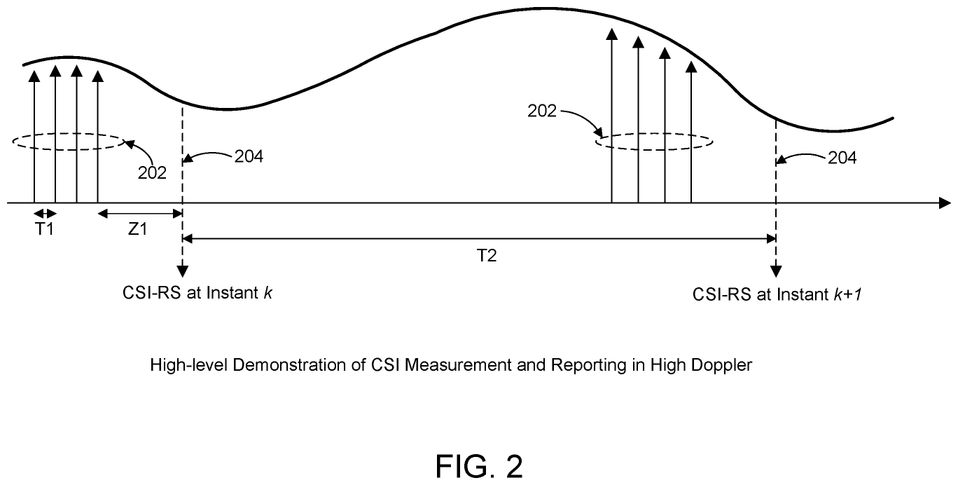

FIG. 2 shows a high-level demonstration of CSI measurement in a high Doppler scenario consisting of two main measurement phases of an initial burst and CSI MIMO measurement. According to the general procedure, the wireless channel is first sampled at a very high rate to capture the Doppler effect on the channel. Then, by using a configured CSI-RS, a WTRU measures the CSI of the MIMO channel. Using the captured Doppler effect from the first measurement, the WTRU may estimate the trend of channel variation for a short window of time and correct the estimated CSI available from the second measurement without requiring an additional sampling opportunity. In the illustrated example, measurement 202 is performed using a first set of configured RS with frequency domain density D1 and number of ports P1, and measurement 204 is performed using a second set of configured RS with frequency domain density D2 and number of ports P2.

The high-level procedure shown in FIG. 2 has some typical features as follows. The rate of the first reference signal may be high enough to be able to correctly capture the effect of high Doppler on channel characteristics and features. The density of the first reference signal may be not less than that of the CSI-RS for MIMO measurement to be able to correctly observe the delay spread of the channel. The number of ports of the first reference signal may be equal or less than of the CSI-RS for MIMO measurement as the stationarity of a MIMO channel may be consistent across different layers.

In an implementation, the procedure for MIMO CSI estimation and reporting in the presence of high Doppler may include one or more of the following:

In a first example implementation, a WTRU may receive first and second reference signal configurations, where both are downlink reference signals with a periodic transmission interval of T2.

In one option, at every reception opportunity defined by T2, a WTRU may receive a first reference signal N1 times an interval transmission time of T1≤T2. A first received reference signal may have a frequency-domain density of D1 (i.e., transmitted at every x subcarrier location). Further, a WTRU may measure the first received reference signal on P1 ports.

In another option, at every reception opportunity marked by T2, a WTRU may receive only a single second reference signal. A second received reference signal may have a frequency-domain density of D2 (i.e., transmitted at every x subcarrier location). The density of the second reference signal may be less than of the first reference signal (i.e., D2≤D1). Further, a WTRU may measure the first received reference signal on P1 ports. The number of ports of the second received signal P2 may be greater than or equal to the number of P1 ports. (i.e., P2≥P1). A WTRU may receive the second RS with a time offset value Z1 from the reception of the first configured RS. In an example, the value of Z1 may be based on a reported WTRU-capability. A WTRU may report CSI using the reporting configuration associated with the second received reference signal.

In another option, different combinations of triggering may be considered for operation of the first and second reference signals (i.e., periodic, aperiodic, and/or semi-persistent). For example, both reference signals may be triggered on a periodic, aperiodic, and/or semi-persistent basis. In another exemplary implementation, to manage the overhead associated with the transmission of reference signals, the second reference signal may be configured based on a periodic transmission, while the first reference signal may be triggered aperiodically or in a semi-persistent manner based on WTRU velocity.

In a second example implementation, a WTRU may receive first and second reference signal configurations, where the first and the second are uplink and downlink reference signals with a periodic transmission interval of T2, respectively.

At every reception opportunity defined by T2, a WTRU may transmit a first reference signal N1 times with an interval transmission time of T1≤T2. A first transmitted reference signal may have a frequency-domain density of D1 (i.e., transmitted at every x subcarrier location). Further, a WTRU may transmit the first configured reference signal on Pt ports. Following transmission of the first reference signal (uplink), a WTRU may receive some Doppler related information from a gNB to assist CSI prediction for the MIMO channel.

At every reception opportunity marked by T2, a WTRU may receive only a single second reference signal. A second received reference signal may have a frequency-domain density of D2 (i.e., transmitted at every x subcarrier location). Here, the density of the second reference signal may be less than of the first reference signal (i.e., D2≤D1). Further, a WTRU may measure the first received reference signal on P1 ports. The number of ports of the second received signal P2 may be greater than or equal to the number of P1 ports. (i.e., P2≥P1). A WTRU may receive the second RS with a time offset value Z1 from the reception of the first configured RS. The value of Z1 may be based on a reported WTRU-capability. A WTRU may report CSI using the reporting configuration associated with the second received reference signal.

Different combinations of triggering may be considered for operation of the first and second reference signals (i.e., periodic, aperiodic, and/or semi-persistent). For example, both reference signals may be triggered on a periodic, aperiodic, and/or semi-persistent basis. In another exemplary implementation, to manage the overhead associated with the transmission of reference signals, the second reference signal may be configured based on a periodic transmission, while the first reference signal may be triggered aperiodically or in a semi-persistent manner based on WTRU velocity.

Configuration of a sounding reference signal (SRS) transmission may be associated with a CSI-RS measurement and reporting. A WTRU may transmit SRS to support a gNB to perform channel measurement at a high rate (i.e., to capture the effect of Doppler). Further, a WTRU may receive information related to the effect of the high Doppler on the wireless channel. A WTRU may perform a CSI measurement on a MIMO channel and report, using a configured CSI configuration. SRS configuration may or may not have the same number of CSI ports as the actual MIMO transmission, even if the configured CSI-RS does. A WTRU may receive a single trigger to initiate transmission of the configured SRS, and reception of the CSI-RS.

In a third example implementation, the first RS and CSI-RS may be configured by radio resource control (RRC) and/or MAC control element (CE) for a specific set of transmission opportunities (i.e., multi-shot operation), where each set of a transmission opportunity may also include a combination of one or more of values of T1 and T2 time intervals, D1 and D2 reference signal density in frequency domain, number of port, triggering types, etc., where each configuration may be selected by a dynamic signaling (e.g., a DCI).

Tracking Reference Signal (TRS) Association with CSI for CSI

In an implementation, a WTRU may receive a DCI indicating/triggering both the first RS (e.g., an aperiodic tracking RS (A-TRS), a burst format of A-TRS, a multi-shot TRS, a second CSI-RS resource, etc.) and the CSI-RS for CSI, where the WTRU may determine a parameter value representing a Doppler effect based on measuring the first RS. Triggering both the first RS and the CSI-RS for CSI may be based on a pre-configured/activated codepoint of a field (e.g., a CSI request field, a separate/new field, and/or an existing field) of the DCI, where the codepoint may be configured by RRC and/or activated via a MAC-CE. The codepoint may indicate at least one measurement timing parameter which may indicate one or more measurement time instances/slots/symbols of DL signals of the first RS and CSI-RS for CSI, based on a reception time instance/slot/symbol of the DCI.

Hereafter, for the brevity of discussion, the first RS may be an A-TRS (resource); however, the proposed implementations and processes may equally (or equivalently or extendedly, etc.) be employed for other examples (e.g., a burst format of A-TRS, a multi-shot TRS, a second CSI-RS resource, etc.) for the first RS.

In an example, the WTRU may receive the DCI, on slot K (within which the last symbol index of the DCI being received may be L), indicating the codepoint, where the codepoint may be pre-configured/activated as indicating X repeated transmissions of an A-TRS resource to be started M symbols later from (e.g., based on) the last symbol (or a symbol) of the DCI being received. The codepoint may (further) be pre-configured/activated as indicating a CSI-RS resource for CSI to be transmitted N symbols later from (e.g., based on) the last symbol (or a symbol) of the last (X-th) transmission of the A-TRS resource. In response to receiving the DCI, the WTRU may determine a first measurement symbol for the first repeated transmission of the A-TRS resource as M symbols after the symbol index L of slot K, and starting from (e.g., based on) the first measurement symbol, the WTRU may receive (e.g., measure) the X repeated transmissions of the A-TRS resource. The WTRU may derive the parameter value representing the Doppler effect based on receiving/measuring the X repeated transmissions of the A-TRS resource.

The WTRU may determine a second measurement symbol for starting the transmission of the CSI-RS resource for CSI based on the first measurement symbol, X, and N (e.g., where the second measurement symbol may be N symbols after (e.g., based on) the last symbol (or a symbol) of the last (X-th) transmission of the A-TRS resource). The WTRU may receive (e.g., measure) the CSI-RS resource for CSI based on (e.g., starting from) the second measurement symbol. The WTRU may determine (e.g., derive) a CSI (e.g., RI, precoding matrix indicator (PMI), channel quality indicator (CQI), layer-indication (LI), etc.) based on the parameter value representing the Doppler effect and based on measuring the CSI-RS resource for CSI. The WTRU may transmit (e.g., report) the CSI (and/or the parameter value representing the Doppler effect) (e.g., (to a gNB) in a CSI reporting instance/slot/symbol). The CSI reporting instance/slot/symbol may be determined based on the DCI (e.g., based on the (CSI request) field of the DCI). This determination may improve a downlink performance based on the CSI being reported being derived based on using the parameter value representing the Doppler effect. This derivation may improve a downlink performance based on flexible/configurable parameters of X, M, and/or N which may allow reduced latency between a X-th transmission timing of the A-TRS resource and a transmission timing of the CSI-RS resource for CSI. This flexibility may reduce signaling overhead in informing the WTRU of the first measurement symbol and the second measurement symbol which may be determined by the WTRU based on the DCI reception timing, X, M, and/or N.

The WTRU may (be configured to) separately transmit/report a parameter value representing a Doppler effect based on measuring the first RS.

In an implementation, the first RS (e.g., the A-TRS) may be configured as a part of the CSI-RS for CSI. The part of the CSI-RS for CSI may comprise a subset of antenna ports (APs) of the CSI-RS for CSI, and/or RE position of the subset of APs, etc. The subset of APs (as being the part of the CSI-RS for CSI) may be determined based on the configured number of APs of the CSI-RS resource.

In an example, the WTRU may determine that a number of APs for the first RS (e.g., corresponding to the subset of APs) is 1 when the configured number of APs for the CSI-RS resource for CSI is less than or equal to P1 (e.g., P1=4).

In an example, the WTRU may determine that a number of APs for the first RS (e.g., corresponding to the subset of APs) is 2 when the configured number of APs for the CSI-RS resource for CSI is less than or equal to P2 (e.g., P1=8).

In an example, the WTRU may determine that a number of APs for the first RS (e.g., corresponding to the subset of APs) is 4 when the configured number of APs for the CSI-RS resource for CSI is less than or equal to P3 (e.g., P3=16, 32, etc.).

In an example, the WTRU may determine that a number of APs for the first RS (e.g., corresponding to the subset of APs) is 8 when the configured number of APs for the CSI-RS resource for CSI is less than or equal to P4 (e.g., P4=16, 32, etc.).

The RE position/distribution (e.g., in a frequency domain) of the determined/indicated APs for the first RS may be based on the RE position/distribution of the same APs of the CSI-RS resource for CSI. In an example, the subset of APs (e.g., the determined APs for the first RS) may be selected/determined to be evenly spaced (e.g., sampled) in a frequency-domain, being captured from the APs of the CSI-RS for CSI (e.g., which may correspond to the RE position/distribution of the APs for the first RS).

Determining the number of APs for the first RS based on the number of APs for the CSI-RS for CSI may improve reliability, flexibility, and efficiency in determining/indicating the number of APs for the first RS without separate control signal signaling, and the increased number of APs for the first RS as the increased configured number of APs for the CSI-RS for CSI may provide reliability/efficiency in measuring those RSs (e.g., in terms of power differences across RE positions/distribution in a frequency domain for those RSs).

In an implementation, the WTRU may (implicitly) determine the first RS being associated with the CSI-RS for CSI, based on a quasi co-location (QCL) property/configuration of the CSI-RS for CSI. In an example, the WTRU may determine the first RS, which has (e.g., is configured with) a first QCL source (e.g., a periodic TRS, a synchronization signal block (SSB) index, etc.), when the first QCL source is the same as (e.g., identical to, associated with, linked to, having an equivalent QCL chain with, etc.) a second QCL source of the CSI-RS for CSI.

In an example, the WTRU may only expect that the first QCL source and/or the second QCL source is a periodic TRS. In an example, the WTRU may be configured with a second periodic TRS as a QCL source of the CSI-RS for CSI. The WTRU may determine the first RS is an RS (resource) which has a QCL source of (e.g., based on) the second periodic TRS. The WTRU may determine that a second RS (resource) also has the same QCL source of the second periodic TRS. In response to the determining, the WTRU may determine the first RS to be the closest RS prior to the CSI-RS for CSI in the time-domain, which may improve reliability and efficiency in estimating the Doppler effect based on the first RS to be used for the CSI derivation based on the CSI-RS for CSI.

### CSI-RS for CSI

### Enhanced CSI-RS Repetition in Frequency

### WTRU Determines CSI-RS Configuration in Frequency Domain Based on Doppler.

A WTRU may be semi-statically configured with more than one frequency domain density configuration (e.g., more than one bitmap of resource block (RB) allocation for CSI-RS) for a CSI-RS resource setting, and a WTRU may dynamically choose a frequency domain configuration based on the Doppler. For example, a WTRU may receive a CSI report setting with a Doppler threshold, and a WTRU may determine the RBs to monitor as a function of the Doppler. For example, when the Doppler is above a threshold, a WTRU may monitor X RBs, and if the Doppler is below a threshold a WTRU may monitor Y RBs, where Y>X.

Alternatively, a WTRU may receive a configuration for a CSI-RS burst that may be defined over an initial set of RBs, and a repetition number with an offset parameter in frequency. The offset may define the separation between repetitions in frequency. The WTRU may determine to measure the CSI over the CSI-RS burst repeated in frequency when the Doppler is above a threshold. For example, if the WTRU measures a Doppler above a threshold, a WTRU may determine that every even RB may be used for measuring CSI, and the CSI-RS transmission in every even RB is a repetition of the first RB. If the WTRU measures a Doppler below a threshold, a WTRU may determine that only the first RB may be used for measuring CSI. A WTRU may determine the number of repetitions based on a Doppler value above a threshold as well.

A WTRU may indicate in a CSI report indicating which frequency domain configuration the WTRU used for determining CSI. For example, a WTRU may include a flag or bitmap which indicates that the associated CSI (e.g., PMI, rank indicator (RI), LI, CQI, and/or CRI) is conditioned on measurements made on X or Y RBs. Alternatively, a WTRU may include the Doppler in the CSI report and implicitly signal X or Y to the network based on the indicated Doppler.

A WTRU may monitor a subset of all RBs in the BWP, measure the channel on the RB subset, and may report a CSI for all RBs of the BWP. For example, a CSI-RS burst may consist of N<N_PRB (physical resource block) consecutive RBs in frequency domain (e.g., RB 0 to N−1) where a WTRU may receive CSI-RS. The burst may also be configured in number of resource elements (RE)s. N_PRB may correspond to the total number of RBs configured in a BWP. A WTRU may determine the Type II CSI basis function indices and coefficients over the N RB subset of the BWP, and the WTRU may report the basis function and coefficients to the network. A WTRU may indicate in its CSI report (e.g., a one bit flag in uplink control information (UCI)) whether the reported CSI was measured over the subset N of RBs or over the entire configured CSI-RS bandwidth N_PRB.

The burst may be configured to only transmit CSI-RS in a subset of all PRBs. The WTRU may report a CSI even for RBs without CSI-RS by applying an extension or predictive function to estimate the channel based on the samples received in the burst. A WTRU may use a predictive function to estimate the channel over N_PRB samples using only N samples from the CSI-RS burst. The WTRU may receive a codebook of predictive functions to use and a WTRU may report an index of the selected predictive function along with the measurements made on N samples. A CSI-RS resource setting may be toggled between burst and non-burst mode based on a flag in the setting. The flag may be semi-statically activated based on a MAC-CE. A WTRU may determine whether or not to use a predictive function based on a measured Doppler being above a threshold.

For example, a WTRU may measure a channel vector H_N over N samples. A WTRU may use a predictive function F of dimensions N_PRB-by-N to generate an estimate of size N_PRB for the channel as: H_NPRB=F*H_N. A WTRU may determine F from a preconfigured codebook of F functions. A WTRU may receive the codebook of F as part of the CSI report setting. Alternatively, a WTRU may report H_N only with a flag to indicate that the network should use a predictive function. The network may apply the predictive function F and may determine the WTRU's channel over N_PRBs. This method may reduce the overhead of CSI-RS so that only N out of N_PRB samples may contain CSI-RS.

### Enhancements to Type II CSI Reporting and Priority Levels for Feedback Reduction

### Switching Between CSI Modes

### CSI Mode Definition

In an implementation, one or more CSI modes may be used, wherein a CSI mode may be associated with one or more of the following seven conditions.

(1) Reporting bandwidth or type (e.g., subband or wideband) of one or more CSI reporting quantities including at least one of: (a) precoding matrix information associated with a component precoder, wherein the component precoder may be a part of a precoding matrix which may include one or more component precoding matrices. For example, a precoding matrix (W) may be defined as W=W₁W₂, where W₁ and W₂ may be referred to as a component precoder, or a component precoding matrix. Hereafter, precoding matrix (W), which may include one or more component precoding matrices, may be interchangeably used with a composite precoding matrix, composite precoder, precoder, and/or precoder matrix. (b) channel quality indicator (CQI), wherein CQI may be estimated, calculated, or determined based on a determined precoding matrix. (c) rank or number of layers. (d) sub-parameter of a component precoder. For example, a component precoder may include one or more parameters (e.g., power scaling and/or co-phasing parameter). In an example, a first CSI mode may be associated with a wideband power scaling of a component precoder (e.g., W₂) while a second CSI mode may be associated with a subband power scaling.

(2) Subband size of one or more CSI reporting quantities, wherein the subband size may determine the number of bits to report for the CSI.

(3) CSI reporting channel/resource. For example, CSI reporting channel/resource may be at least one of physical uplink control channel (PUCCH), physical uplink shared channel (PUSCH), SRS, and/or random access channel (RACH) resource (e.g., physical random access channel (PRACH) preamble and/or RACH MsgA).

(4) CSI reporting frequency, wherein the reporting frequency may include at least one of periodic, aperiodic, and/or semi-persistent.

(5) CSI measurement resource. For example, CSI measurement resource may include at least one of SSB, CSI-RS, TRS, SRS, positioning RS (PRS), demodulation RS (DMRS), and/or phase tracking reference signal (PTRS). The measurement resource may be dependent on CSI mode, wherein the measurement resource for a specific measurement may be determined based on the CSI mode. The specific measurement may be at least one of Doppler frequency, mobility, WTRU speed, time coherency, Doppler shift, or QCL parameter.

(6) Number of transmit receive points (TRPs) configured for a CSI reporting.

(7) Number of panels used, assumed, and/or considered for a CSI reporting.

### CSI Mode Determination

In an implementation, one or more CSI modes may be defined or used and a WTRU may determine a CSI mode based on one or more of the following six conditions.

(1) A level of Doppler frequency from a measurement. For example, a WTRU may perform a measurement of Doppler frequency and, based on the level of Doppler frequency, the WTRU may determine a CSI mode, wherein Doppler frequency may be interchangeably used with WTRU speed, WTRU velocity, WTRU mobility, channel coherent time, and/or channel time coherency. One or more Doppler frequency thresholds may be used, configured, and/or predetermined; a CSI mode may be determined if the measured Doppler frequency is within a threshold.

(2) A level of frequency selectivity of the channel. For example, a WTRU may perform a measurement of channel frequency selectivity and the WTRU may determine a CSI mode based on the measured frequency selectivity. The frequency selectivity may be interchangeably used with delay spread, channel frequency coherency, and/or coherent bandwidth. One or more coherent bandwidth thresholds may be used, configured, and/or predetermined; a CSI mode may be determined if the measured coherent bandwidth is within a threshold.

(3) Uplink resource determined for a CSI reporting.

(4) Measurement resource configured for a CSI reporting.

(5) Number of TRPs associated with the CSI reporting.

(6) Number of panels used, assumed, and/or considered for a CSI reporting.

In another implementation, a WTRU may be explicitly indicated by a gNB which CSI mode to use. For example, a higher layer configuration (e.g., SIB, RRC, and/or MAC-CE) may be used to indicate CSI mode to use per carrier, bandwidth part (BWP), CSI reporting configuration, and/or TRP. In another example, a dynamic indication (e.g., DCI) may be used to indicate CSI mode to use when a CSI reporting is triggered and/or for a CSI reporting instance at a future time.

A WTRU may report CSI based on the determined CSI mode. An uplink resource and CSI reporting format/contents may be determined based on the determined CSI mode.

### CSI Mode Indication

In an implementation, a WTRU may indicate or report a determined CSI mode when a CSI mode is determined implicitly or autonomously. The determined CSI mode hereafter may be referred to as a CSI Mode Identity (CMI) but interchangeably used with Doppler Frequency Mode (CFM), WTRU-speed based CSI Mode (USM), and so forth. The WTRU may report CMI based on one or more of the following three conditions.

(1) One or more uplink resources may be configured or used and each uplink resource may be associated with a CSI mode. A WTRU may determine an uplink resource based on the determined CMI and report its associated CSI. The one or more uplink resources may be mutually orthogonal in time, frequency, code, and/or spatial domain.

(2) CMI may be reported as a part of CSI. For example, when a WTRU reports CSI, which may be dependent on the CMI determined, the WTRU may report CMI together with the CSI. CMI may be separately encoded from its associated CSI. Therefore, a receiver may perform decoding CMI first to determine the information size of the CSI and perform decoding of its associated CSI. CMI may be jointly encoded with its associated CSI; a receiver may perform blind decoding for the CMI and its associated CSI.

(3) CMI may be reported before the reporting of its associated CSI. For example, CMI may be reported periodically and CMI of a CSI reporting at slot #n may be determined based on the latest CMI reported earlier than n-x slots, wherein x may be a processing time.

### Methods for Reporting Indices of Non-Zero Subband Coefficients

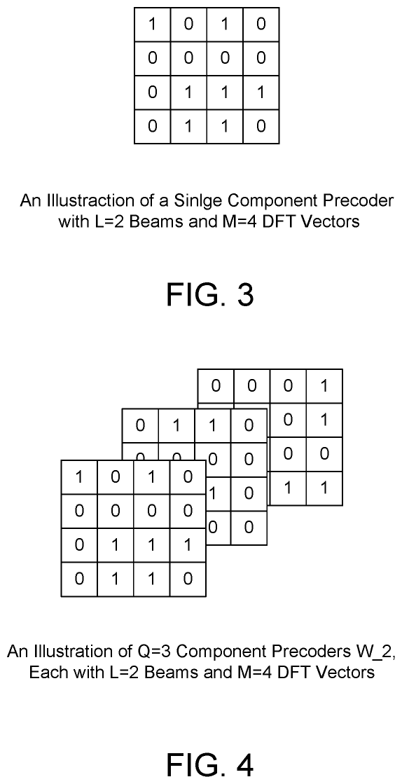

An illustration of a single co-phasing coefficient matrix W_2 or component precoder W_2 is provided in FIG. 3. In FIG. 3, each row indicates a polarization of a beam. The number of rows indicates the number of beams times the number of polarizations. In an example, the component precoder in W_2 has L=2 beams and each beam has 2 polarizations. The component precoder in FIG. 3 therefore has 4 rows. Each column indicates a DFT vector, and the number of columns indicates the number of DFT vectors.

Hereinafter: The polarization of a beam may be interchangeably used with row. A DFT vector may be interchangeably used with a column. The number of beams times polarizations may be interchangeably used with the number of rows. The number of DFT vectors may be interchangeably used with the number of columns.

Due to frequency domain compression of the component precoder, not all coefficient of the component precoder are non-zero. Non-zero coefficients (NZCs) are denoted by 1's and zero-coefficients (ZCs) are denoted by 0's. Non-zero coefficients may be interchangeably used with 1's. Zero coefficients may be interchangeably used with 0's

The WTRU needs to report the indices of the zero and the non-zero coefficients on the L beams and on the Mᵥ DFT vectors in a CSI report. The number of non-zero coefficients may be bounded as a function of the number of W_2 matrices and/or the number of rows and/or the number of columns and/or a frequency domain compression scaling factor β. The number of non-zero coefficients in each W_2 matrix may be bounded as K₀≤┌β2LM₁┐, where β is a frequency domain compression scaling factor, M₁ is the number of DFT vectors for one layer, L is the number of beams with 2 polarizations. The number of NZCs on each layer is bounded as Kₗ^{NZ}≤K₀, where l=1, . . . , v and where v is the total number of layers and the number of non-zero coefficients on all layers is bounded as Kₗ^{NZ}≤2K₀. A bitmap of length 2LMᵥ may be used to indicate the indices of the zero and non-zero coefficients. In the bitmap, the use of a “1” is used to indicate the index of a non-zero coefficient and the use of a “0” may be used to indicate a zero coefficient.

For rapidly changing channels, long-term channel statistics e.g., component precoder W_1 may remain constant for longer durations. However, for rapidly changing channels. e.g., a wireless channel experienced by a WTRU at high velocity, the co-phasing coefficients, or the component precoder W_2 will change at a faster rate. At high WTRU velocity, a WTRU may report one or more component precoders W_2 for a fixed component precoder W_1. In an example, a WTRU may report Q number of component precoders W_2 for a single component precoder W_1. This may increase the total number of non-zero coefficients from K^{NZ}≤┌β2LM_1┐ to K_{D}^{NZ}┌β2LM₁Q┐. For illustrative purposes, Q=3 co-phasing coefficient matrices with L=2 beams and M=4 DFT is as shown as in FIG. 4.

### Method 1

A WTRU may report combinations of the beam and DFT vector indices. As an illustrative example, K₀ number of NZCs over L beams and Mᵥ vectors can form

$$( \begin{matrix}2 {LM}_{v} \\ {K}_{0}\end{matrix} ) = \frac{2 {LM}_{v} !}{{K}_{0} ! ( 2 {LM}_{v} - {K}_{0} ) !}$$

distinct combinations, where (.)! is the factorial operation. The number of bits required to indicate the indices of K₀ NZCs is

$$⌈ {log}_{2} ( \begin{matrix}2 {LM}_{v} \\ {K}_{0}\end{matrix} ) ⌉$$

bits. The maximum number of beam and DFT vector combinations pertaining to the NZCs occur when the number of NZC K₀ equals,

$${K}_{0} = \frac{2 {LM}_{v}}{2} .$$

It can be mathematically proven that

$$⌈ {log}_{2} ( \begin{matrix}2 {LM}_{v} \\ {LM}_{v}\end{matrix} ) ⌉ < 2 L {M}_{v} .$$

Therefore, this type of reporting can achieve smaller feedback overhead as compared to using a bitmap of length 2LMᵥ.

The feedback overhead pertaining to the combinatorial reporting increases when increasing K₀. It reaches the maximum value when K₀=2LMᵥ/2 and then starts decreasing until K₀ reaches K₀=2LMᵥ. Therefore, the minimum feedback overhead (i.e., one bit overhead for reporting the indices of NZCs) can be achieved when K₀=10 or K₀=2LMᵥ. Smaller feedback overheads can be achieved when K₀≤LMᵥ/2 or K₀≥1.5LMᵥ. However, when increasing K₀, the feedback overhead pertaining to reporting the coefficient values of NZCs (i.e., the subband and phase coefficient values) also increases. Therefore, for overall feedback reduction, it is wise to ensure the use of K₀≤LMᵥ/2, which can be achieved by introducing smaller values of the frequency domain parameters pᵥ and β.

In one example method, a WTRU may switch the reporting procedure for reporting the locations and/or indices of the non-zero coefficients from a first procedure to a second procedure. The first procedure may involve or result in the production of a bitmap of length 2LM_v and the second procedure may involve or result in the production of a bitmap of length

$$⌈ {log}_{2} ( \begin{matrix}2 {LM}_{v} \\ {K}_{0}\end{matrix} ) ⌉ ,$$

where Kₒ may be the upper bound on the number of non-zero coefficients in the component precoder W_2 or Kₒ may be the actual number of non-zero coefficients in the component precoder W_2.

A WTRU may perform one or more of the following six options.

(1) A WTRU may determine the number of non-zero coefficients in one or more component precoders.

(2) A WTRU may determine a threshold on the number of non-zero coefficients. In an example, a WTRU may determine a threshold as: (a) The number of non-zero coefficients is less than and/or equal to a first threshold (e.g., threshold a) and/or, (b) the number of non-zero coefficients is greater than and/or equal to a second threshold (e.g., threshold b).

(3) A WTRU may determine if the number of zero coefficients is greater than, equal to, or less than the number of non-zero coefficients.

(4) A WTRU may determine threshold “a” and/or threshold “b” based on its capability.

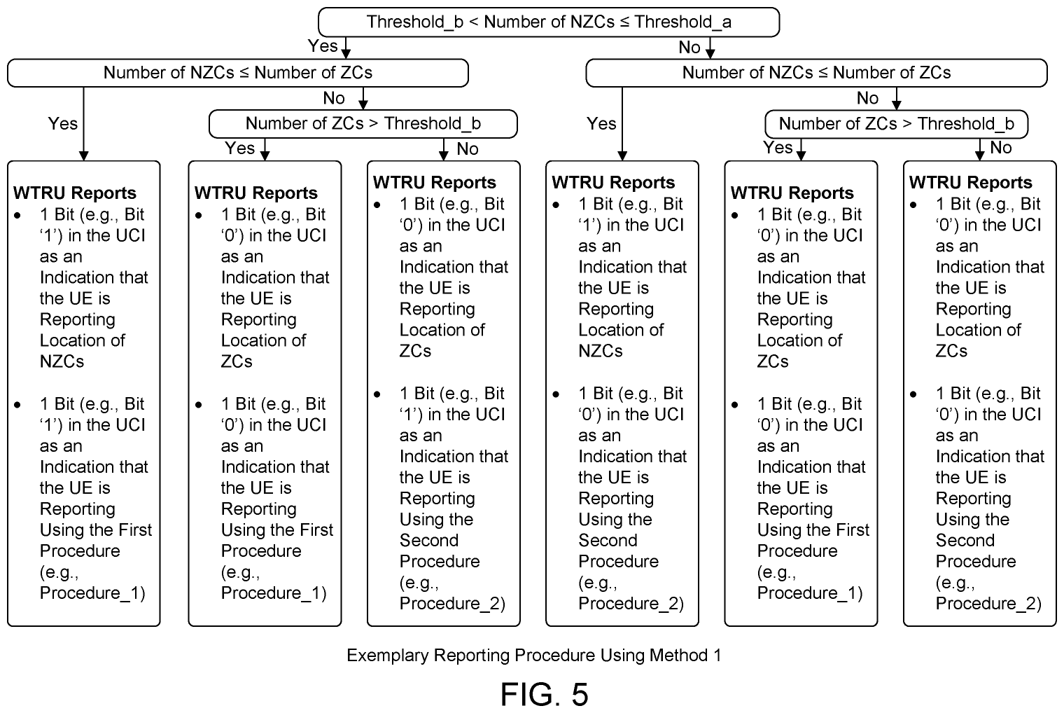

(5) A WTRU may perform a reporting procedure, such as either a first reporting procedure or a second reporting procedure, and a reporting type, such as either reporting Non-zero Coefficients (NZC) or Zero Coefficients (ZC)). A WTRU may perform the exemplary procedures depicted in FIG. 5 to determine when to use the first or second reporting procedure and when to report a NZC or ZC type of reporting. In one example, when reporting the locations of NZCs for one or more component precoders, where: (a) Threshold “a” is less than half of the total number of coefficients. (b) Threshold “b” is greater than half of the total number of coefficients.

(6) Based on threshold “a”, threshold “b”, number of NZCs, and/or number of ZCs, a WTRU may perform one or more of the following: (a) A WTRU may report an indication of the reporting procedure (e.g., the first procedure or the second procedure) in the CSI report carrying the component precoder. (b) A WTRU may report an indication of the reporting type (e.g., reporting locations of NZCs or locations of ZCs) in the CSI report carrying the component precoder.

In an alternative example method, a WTRU may receive a configuration through (e.g., SIB, RRC and/or MAC-CE) or a more dynamic DCI indication for reporting locations of NZCs or ZCs using the first procedure or the second procedure.

### Method 2

The component precoder W_2 is a sparse matrix due to frequency domain compression. Reporting locations of NZCs in multiple W_2 matrices require large feedback overhead.

In an example method, a WTRU may perform one or more of the following.

For each component precoder W_2 (e.g, for each of Q=3 component precoders in FIG. 3), a WTRU may first report the number of 1's on each column of a W_2 matrix using a first indication. (a) In an example, WTRU may first report the number of NZCs on each column of a W_2 matrix using a first indication (e.g., a bitmap of ┌log₂(2L+1)┐ bits in the UCI). (b) A WTRU may report the number of 1's in a column only for Mᵥ−1 columns (e.g., only for the first Mᵥ−1 columns) of a W_2 matrix, if the following condition is satisfied. If a WTRU reports the total number of 1's in a W_2 matrix (e.g., as in Rel. 16 reporting of a Type-II PMI).

A WTRU may report row indices of 1's for each column of a component precoder W_2 using a second indication. (a) In one example, a single row index may include an indication or identification of a location of a row in a column where an NZC is present. Multiple row indices may indicate the row identifications/locations of NZCs in multiple columns for each precoder matrix. (a) In an example, a WTRU may report (e.g., row indices) of 1's on each column of a W_2 matrix using a second indication (e.g., a bitmap of

$$⌈ {log}_{2} ( \begin{matrix}2 L \\ {α}_{j}\end{matrix} ) ⌉$$

bits in the UCI, where aⱼ is the number of 1's on column j of a W_2 matrix, reported by the first indication). (b) A WTRU may report row indices of 1's for a column only when, the number of 1's in the column is at least one, and the number of 1's in the column is less than the number of rows of the W_2 matrix.

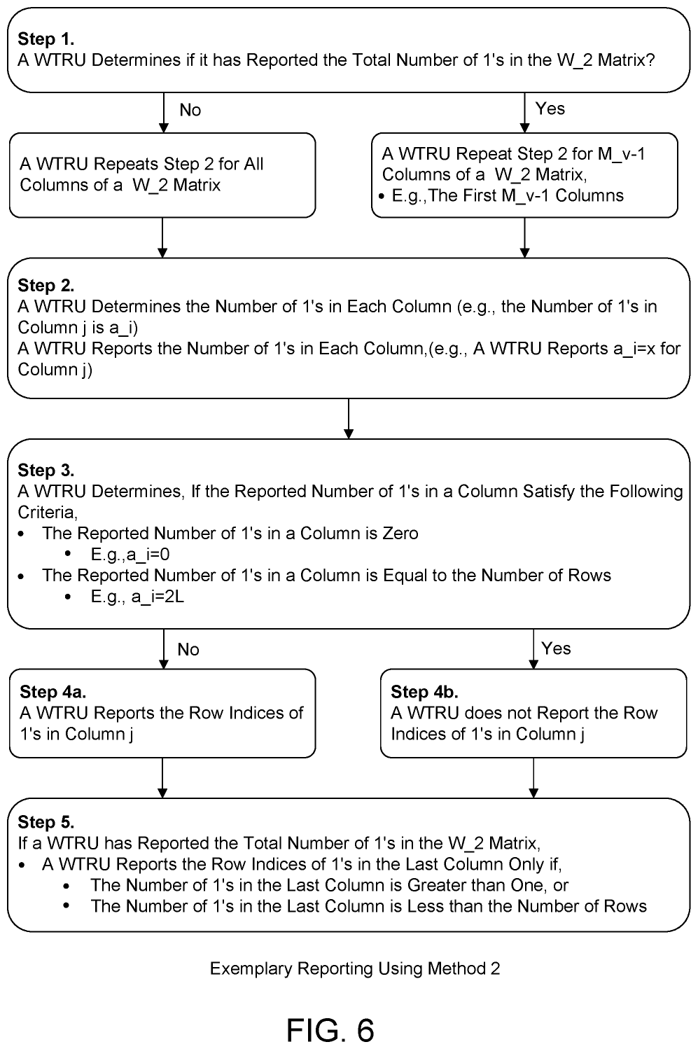

A summary of reporting the NZCs location (e.g., the column and row indices of 1's in the matrix) using method 2 is detailed in FIG. 6.

In step 1 of FIG. 6, the WTRU/UE determines if the total number of 1's in the W_2 Matrix has been reported. Or if the gNB knows the total number of 1's or not]. If no, the WTRU enters step 2 for all columns of a W_2 Matrix. If yes, the WTRU enters step 2 for Mᵥ−1 columns of a W_2 Matrix. For example, the first Mᵥ−1 columns.

In either event, at step 2, the WTRU determines the number of 1's in each column specified after step 1, e.g., all columns or the first M_v−1 columns. For example, the number of 1's in Column j is a_i. A WTRU also reports the number of 1's in each column. For example, a WTRU reports a_i=x for column j.

At FIG. 6 step 3, the WTRU determines if the reported number of 1's in a column satisfy the following criteria: (1) the reported number of 1's in a column is zero. For example, a_i=0. (2) the reported number of 1's in a column is equal to the number of rows. For example, a_i=2L.

If the conditions of step 3 are not satisfied, then at step 4a, the WTRU reports the row indices of 1's in column j. If the conditions of step 3 are satisfied, then a step 4b, the UE/WTRU does not report the row indices of 1's in column j.

At step 5 of FIG. 6, if the WTRU has reported the total number of 1's in the W_2 matrix. The WTRU reports the row indices of 1's in the last column, e.g., M_vth column only if (1) the number of 1's in the last column is greater than one or (2) the number of 1's in the last column is less than the number of rows. One benefit of the procedure of FIG. 6 is a more efficient communication of precoding matrix information to a network entity by reducing the amount of data to be transmitted.

### Method 3

In an example method, a WTRU may perform one or more of the following.

For each component precoder W_2 (e.g., for each of Q=3 component precoders in FIG. 4), a WTRU may first report the number of 1's on each row of a W_2 matrix using a first indication. (a) In an example, a WTRU may first report the number of 1's on each row of a W_2 matrix using a first indication (e.g., a bitmap of ┌log₂(Mᵥ+1)┐ bits in the UCI). (b) A WTRU may report the number of 1's in a row only for 2L−1 rows (e.g., only for the first 2L−1 rows) of a W_2 matrix, if the following condition is satisfied. If a WTRU reports the total number of 1's in a W_2 matrix (e.g., as in Rel. 16 reporting of a Type-II PMI).

A WTRU may report column indices of 1's for each row of a component precoder W_2 using a second indication. (a) In an example, a WTRU may report (e.g., column indices) of 1's on each row of a W_2 matrix using a second indication (e.g., a bitmap of

$$⌈ {log}_{2} ( \begin{matrix}2 L \\ {α}_{l}\end{matrix} ) ⌉$$

bits in the UCI, where αₗ is the number of 1's on row 1 of a W_2 matrix, reported by the first indication). (b) A WTRU may report column indices of 1's for a row only when, the number of 1's in the row is at least one, and, the number of 1's in the row is less than the number of columns of the W_2 matrix.

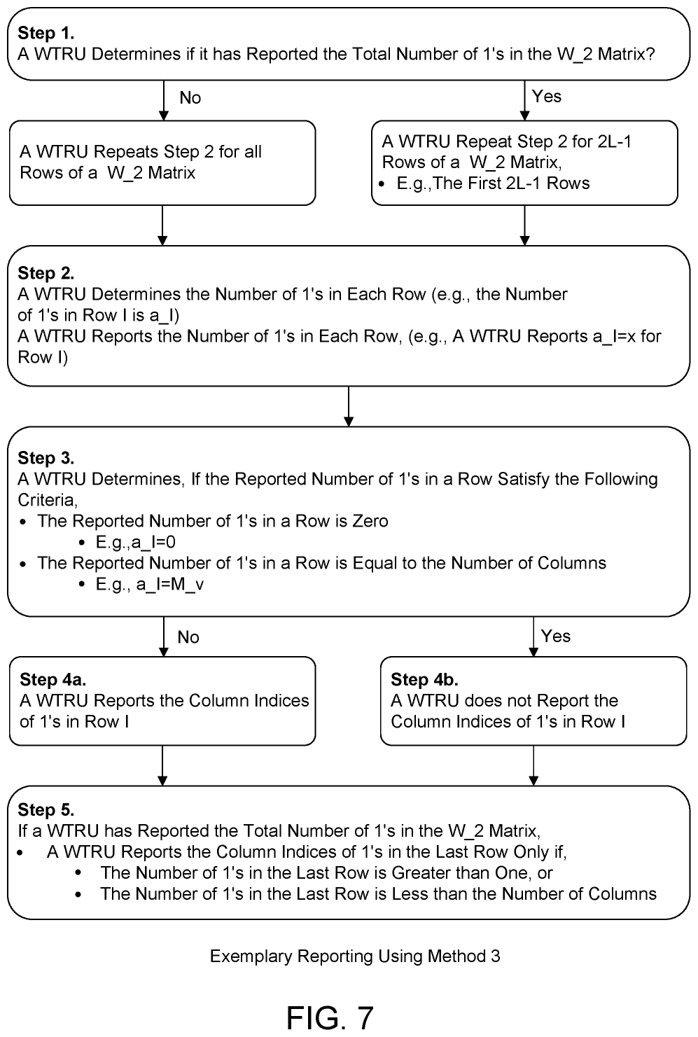

A summary of reporting the NZCs location (e.g., the column and row indices of 1's in the matrix) using method 3 is detailed in FIG. 7. In FIG. 7, a similar procedure is used as in FIG. 6, but with a reversal of the use of rows and columns and a repetition of step 2 for a different number of elements in the W_2 Matrix in order to configure reporting.

In step 1 of FIG. 7, the WTRU/UE determines if the total number of 1's in the W_2 Matrix has been reported. If no, the WTRU enters step 2 for all rows of a W_2 Matrix. If yes, the WTRU enters step 2 for 2L−1 rows of a W_2 Matrix. For example, the first 2L−1 rows.

In either event, at step 2, the WTRU determines the number of 1's in each row specified after step 1, e.g., all row or the first 2L−1 rows. For example, the number of 1's in row I is a_iI. A WTRU also reports the number of 1's in each row. For example, a WTRU reports a_I=x for row I.

At FIG. 7, step 3, the WTRU determines if the reported number of 1's in a row satisfy the following criteria: (1) the reported number of 1's in a row is zero. For example, a_I=0. (2) the reported number of 1's in a row is equal to the number of columns. For example, a_I=Mᵥ.

If the conditions of step 3 are not satisfied, then at step 4a, the WTRU reports the column indices of 1's in row I. If the conditions of step 3 are satisfied, then at step 4b, the WTRU does not report the column indices of 1's in row I.

At step 5 of FIG. 7, the WTRU has reported the total number of 1's in the W_2 matrix. The WTRU reports the column indices of 1's in the last row only if (1) the number of 1's in the last row is greater than one or (2) the number of 1's int e last row is less than the number of columns. One benefit of the procedure of FIG. 7 is a more efficient communication of precoding matrix information to a network entity by reducing the amount of data to be transmitted.

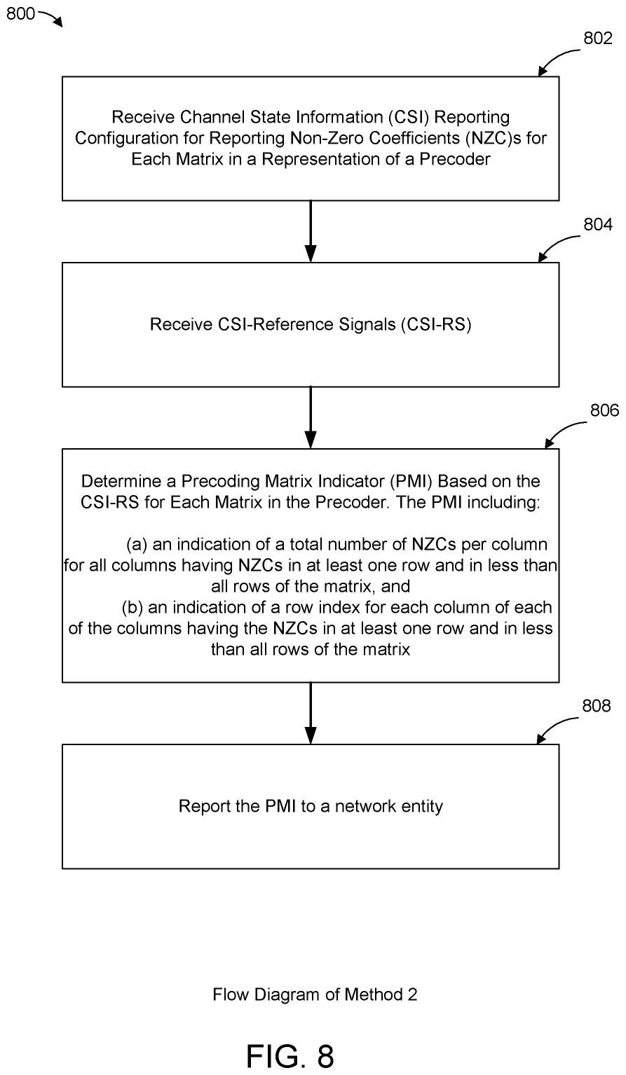

FIG. 8 is an example method 800 of Method 2. The method 800 may be performed by a WTRU/UE. At 802, the WTRU receives a channel state information (CSI) reporting configuration information. The configuration information indicating (i) a plurality of matrices, (ii) for each of the plurality of matrices, a total number of rows and columns, and (iii) an indication to report on non-zero coefficients (NZCs) useful for precoder matrix information.

At 804, the WTRU receives one or more channel state information reference signals (CSI-RS).

At 806, the WTRU determines a precoding matrix indicator (PMI) based on channel measurements associated with one or more CSI-RS. Here, the PMI includes, for each matrix of the plurality of matrices: (a) an indication of a total number of NZCs per column for all columns having NZCs in at least one row and in less than all rows of the matrix, and (b) an indication of a row index for each column of each of the columns having the NZCs in at least one row and in less than all rows of the matrix.

At 808, the WTRU can report the PMI to a network entity such as a gNB, base station, or other WTRU.

In the method 800, the WTRU may determine PMI using indications of NZCs per column and per row. The indications may have either a zero or a one binary value.

In the method 800, the WTRU may determine PMI by generating information where any indication in a row corresponds to a polarization of a beam and where any indication in a column corresponds to a DFT vector.

In method 800, the WTRU may report the PMI to a network entity such that reporting PMI that lacks NZC values for any column having all zero coefficient indicators. Also, such reporting may include reporting PMI having a row index that includes an identification or location indication of a row in a column that has a NZC value.

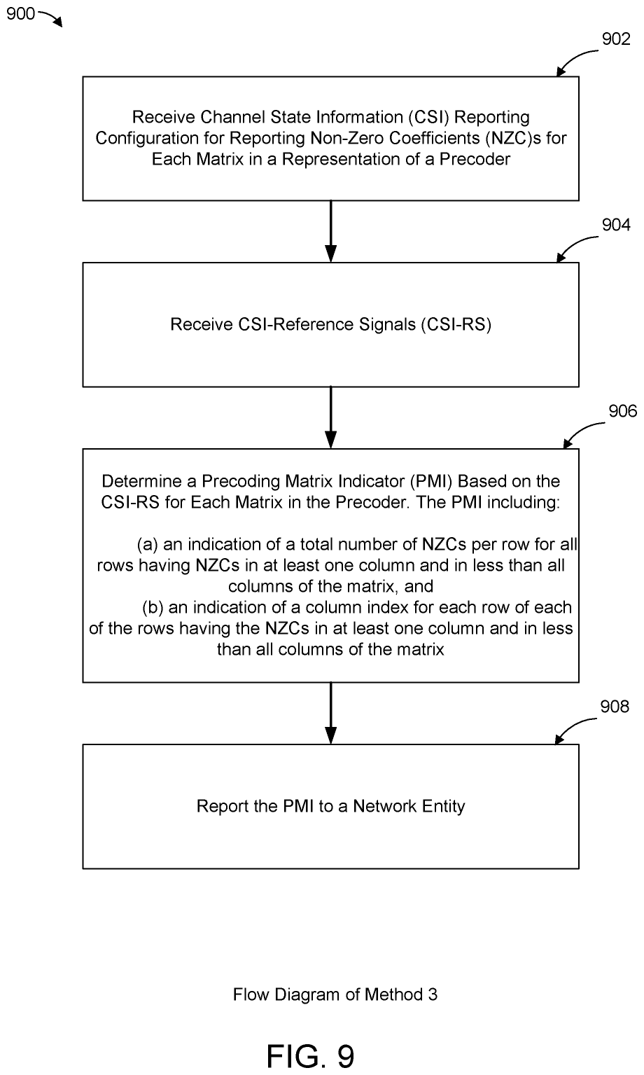

FIG. 9 is an example method 900 of Method 3. The method 900 may be performed by a WTRU/UE. At 902, the WTRU receives a channel state information (CSI) reporting configuration information. The configuration information indicating (i) a plurality of matrices, (ii) for each of the plurality of matrices, a total number of rows and columns, and (iii) an indication to report on non-zero coefficients (NZCs) useful for precoder matrix information.

At 904, the WTRU receives one or more channel state information reference signals (CSI-RS).

At 906, the WTRU determines a precoding matrix indicator (PMI) based on channel measurements associated with the one or more CSI-RS. Here, the PMI includes, for each matrix of the plurality of matrices: (a) an indication of a total number of NZCs per row for all rows having NZCs in at least one column and in less than all columns of the matrix, and (b) an indication of a column index for each row of each of the rows having the NZCs in at least one column and in less than all columns of the matrix.

At 908, the WTRU can report the PMI to a network entity such as a gNB, base station, or other WTRU.

In the method 900, the WTRU may determine PMI using indications of NZCs per column and per row. The indications may have either a zero or a one binary value.

In the method 900, the WTRU may determine PMI by generating information where any indication in a row corresponds to a polarization of a beam and where any indication in a column corresponds to a DFT vector.

In the method 900, the WTRU may report the PMI to a network entity such that reporting PMI that lacks NZC values for any row having all zero coefficient indicators. Also, such reporting may include reporting PMI having a column index that includes an identification or location indication of a column in a row that has a NZC value.

### Reporting Mode Determination

In a first example, one or more reporting modes may be defined or used, and a WTRU may determine a reporting mode based on one or more of the following four options.

(1) The feedback overhead of the Method 1 may depend on the number of beams L and the number of NZCs denoted by K^{NZ}.

(2) The feedback overhead of a Method 2 may depend on the number of DFT vectors Mᵥ, the number of NZCs pertaining to each DFT vector, denoted by αⱼ, for j=1, . . . , Mᵥ, and the number of beams L.

(3) The feedback overhead of Method 3 depends on the number of DFT vectors Mᵥ, the number of NZCs pertaining to each beam, denoted by αₗ, for l=1, . . . , 2L and the number of beams L.

(4) Using a look-up table for different combinations of L, Mᵥ, K^{NZ}, αⱼ and αₗ, based on the corresponding combination feedback overhead.

In a second example for reporting mode determination, a WTRU may receive a CSI reporting configuration. The configuration may include any of the following four configuration elements.

(1) The total number of DFT vectors for a W_2 matrix (e.g., the number of columns in a W_2 matrix).

(2) The total number of beams (e.g., the number of rows in a W_2 matrix).

(3) Total number of component precoders of the PMI (e.g., the total number of W_2 matrices in the PMI).

(4) An indication of a new reporting mode (e.g., Method 1, Method 2, Method 3 or legacy method).

In a third example for reporting mode determination, a WTRU may determine the number of bits needed for reporting row and column location of 1's in a W_2 matrix using method 1 and/or method 2 and/or method 3 by using L, Mᵥ, K^{NZ}, αⱼ and αₗ. (a) In an example, a WTRU may create, which may show the number of bits required for reporting row and column locations of 1's in a W_2 matrix as a function of L, Mᵥ, K^{NZ}, αⱼ and αₗ. (b) A WTRU may indicate its preference of method 1, method 2, method 3 or legacy method in the UCI.

In a fourth example for reporting mode determination, a WTRU may be explicitly indicated by a gNB which reports CSI mode to use (e.g., method 1, method 2, method 3 or legacy method). For example, a higher layer configuration (e.g., SIB, RRC, and/or MAC-CE) may be used to indicate reporting mode to use per carrier, bandwidth part (BWP), CSI reporting configuration, and/or TRP. In another example, a dynamic indication (e.g., DCI) may be used to indicate a reporting mode to use when CSI reporting is triggered or for a CSI reporting instance at a future time.

### Reporting Mode Indication

In an implementation, a WTRU may indicate or report a determined reporting mode when a reporting mode is determined implicitly or autonomously. The determined CSI mode hereafter may be referred to as a Reporting Mode Identity (RMI). The WTRU may report RMI based on one or more of the following two options.

(1) One or more uplink resources may be configured or used, and each uplink resource may be associated with a reporting mode.

(2) RMI may be reported as a part of CSI. RMI may be separately encoded from its associated CSI. Therefore, a receiver may perform decoding RMI first to determine the reporting type (e.g., combinatorial reporting, beam-DFT reporting, and/or DFT-beam reporting) of the NZCs indices and perform decoding of its associated CSI. RMI may be jointly encoded with its associated CSI; a receiver may perform blind decoding for the RMI and its associated CSI.

### Grouping and Priority Levels for CSI Reporting

The payload size of a CSI report is limited. To fit the payload size, the WTRU may prioritize reporting certain elements of a CSI report with higher priorities and certain elements of the CSI report with a smaller priority. In Rel. 17, different elements of a CSI report are divided into different groups. Then, for each group, elements within the group are prioritized for reporting. Considering the reporting procedures disclosed above, different elements of a CSI report may be divided into the following three groups.

Group 0: Indication for the generation of the oversampled DFT beam (i.e., the DFT oversampling indices i_{1,1}=[q₁ q₂] and the indices of the horizontal and vertical antenna elements on the panel i_{1,2}=[n₁ n₂]) may be grouped into group 0. This group may also contain CMI/CFM/USM. This group may also contain subband amplitude threshold (SAT), which is discussed below. This group may also contain RMI. The index of the strongest amplitude coefficient on layer l, which is identified by i_{1,8,l} may also be included in group 0. However, when the joint reporting of subband amplitude coefficients is triggered as explained above, then the indication of the strongest amplitude coefficient index, i.e., i_{1,8,l} may be excluded from group 0 as well as from the CSI report. This group may also contain all the wideband amplitude coefficients, which is identified by i_{2,3,l} for layer l, l=1, . . . , v, where v is the total number of layers.

Group 1: This group may contain indicators i_{1,5} and i_{1,6}, both of which are used to identify the Mᵥ number of DFT vectors. The indicators i_{1,5} and i_{1,6} may be excluded from this group and can be excluded from the CSI report when the WTRU chooses to report only wideband CSI based on CMI/CFM/USM. This group may contain subband amplitude coefficients identified by i_{2,4,l} and the phase coefficients identified by i_{2,5,l}. Considering the higher feedback overhead related to the reporting of NZCs indices, for both i_{2,4,l} and i_{2,5,l}, only LMᵥ/4 or even a smaller number of dominant subband coefficients and phase coefficients may be tagged as high priority and may be included in this group. The priority assignments may be done as in Rel. 17. In a similar fashion, the NZCs indices on the L beams and Mᵥ DFT vectors, which is identified by i_{1,7,l}, is included in group 1. Only LMᵥ/4 or even a smaller number of high priority elements of i_{1,7,l} pertaining to high priority subband and phase coefficients may also be included in group 1.

Group 2: This group may contain the remaining lowest priority elements of i_{1,7,l}, the remaining lowest priority elements of i_{2,4,l} and the remaining lowest priority elements of i_{2,5,l}.

Based on the above-mentioned grouping, for N number of CSI reports, the priority reporting levels may be expressed as in Table 1. Hereinafter, Priority 0 is termed as highest priority, priority 1 is termed as second highest priority, priority 2 is termed as third highest priority and so on.

TABLE 1
Priority levels for CSI reporting

Priority 0
For all CSI reports, CSI elements of group 0 may be reported.
Priority 1
For CSI report 1, CSI elements of group 1 may be reported.
Priority 2
For CSI report 1, CSI elements of group 2 may be reported.
Priority 3
For CSI report 2, CSI elements of group 1 may be reported.
Priority 4
For CSI report 2, CSI elements of group 2 may be reported.

[symbol]

Priority 2N-1
For CSI report N, CSI elements of group 1 may be reported.
Priority 2N
For CSI report N, CSI elements of group 2 may be reported.

Method for Joint Reporting of Sub-Band Amplitude Coefficients with Reduced Feedback Overhead

In Rel. 17, the dominant subband amplitude coefficient indices on L beams and Mᵥ number of DFT vectors, denoted by i_{1,7,l}, is indicated by a bitmap of length 2LMᵥ, where bit 1 is used to indicate the index of a NZC index and bit 0 is used to indicate the index of a ZC index. Moreover, in Rel. 17, each of the quantized subband amplitude coefficients is reported using 3 bits. The NZCs indices i_{1,7,l} may also indicate the indices of the corresponding phase coefficients. In Rel. 17 each quantized phase coefficient is indicated using 4 bits. Overall, this is an expensive reporting process in terms of feedback overhead. Hereinafter, a method for joint reporting of NZCs indices, i.e., i_{1,7,l} and quantized subband amplitude coefficient and subband phase coefficients is proposed. Then, following the proposed method, priority reporting levels for CSI reporting is proposed.

In an example for-joint reporting, the WTRU may perform the following procedures.

The WTRU may report the total number of NZCs on a layer denoted by K^{NZ}. The WTRU may report K^{NZ} using b₁=┌log₂K^{NZ}┐ bits.

The WTRU may group the K^{NZ} number of NZCs into d, 1≤d≤g number of groups, where g is the number of quantization levels (e.g., ┌log₂ g┐ number of bits are used to report a quantized subband amplitude coefficient). The grouping may be expressed as [k₁, k₂, . . . k_{d}], where k₁ is the first group and kᵤ for u=1, . . . , d belongs to one of the g quantization levels as set forth in Table 2, where 1≤|kᵤ|≤g and Σᵤ^{d}|kᵤ|=K^{NZ}. For a given g, the total number of possible quantization levels combinations are as many as 2^{g}−1. For illustrative purposes, the grouping process may be explained using an example as follows. In Rel. 17, g=8 quantization levels are used so that each subband amplitude coefficient can be reported using 3 bits. For the sake of explaining the working principles of the proposed method, all possible quantization levels combinations for g=4 quantization levels are as shown in Table 2.

TABLE 2
Illustrative example of all possible quantization level
combinations for subband amplitude quantized
using g-4 quantization levels

| Group | Beam and DFT vector indices |
|---|---|
| index | combination |
| k1 | [1], [2], [3], [4] |
| k2 | [1, 2], [1, 3], [1, 4], [2, 3], [2, 4], [3, 4] |
| k3 | [1, 2, 3], [1, 2, 4], [1, 3, 4], [2, 3, 4] |
| k4 | [1, 2, 3, 4] |

After the illustrative grouping mentioned above for g=4 quantization levels, the WTRU may report the index of a group and an index of the quantization levels combination within the group, which may be reported using a bitmap of length b₂=┌log₂(2^{g}−1)┐ bits.

Using the two bitmaps of length b₁ and b₂, the WTRU may report the total number of NZCs and the indices of all the NZCs quantization levels. However, at this point, the WTRU has not reported the number of NZCs that belong to each of the quantization levels. The WTRU may report the number of NZCs that belong to each of the quantization levels using the following procedure. For illustrative purposes, such reporting is presented for g=4 quantization levels.

### Reporting the Number of Non-Zero Coefficients Belonging to Each Quantization Level

Group kᵤ denotes the u^{th} group, where i=1, . . . , g. The index of the group and the combination of different quantization levels pertaining to K^{NZ} number of non-zero subband coefficients within the group may be reported by the WTRU using b₂ bits. In the considered illustrative example, k₁=[1], which may be reported using b₂ bits, points to the fact that all NZCs K^{NZ} belongs to the first quantization level. Similarly, k₁=[3], points to the fact that all NZCs K^{NZ} belongs to the third quantization level. The group index i=1 points to the fact that all NZCs belongs to one quantization level. Similarly, k₂=[1,2] points to the fact that some NZCs belong to the first quantization level and some NZCs belong to the second quantization level, whereas the group index u=2 points to the fact that all NZCs belong to only two quantization levels. Similarly, k₃=[1,3,4] points to the fact that some NZCs belongs to the first quantization level, some NZCs belong to the third quantization level and some NZCs belong to the fourth quantization level, whereas the group index u=3 points to the fact that all NZCs belongs to only three quantization levels. Similarly, k₄=[1,2,3,4] points to the fact that some NZCs belongs to the first quantization level, some NZCs belongs to the second quantization level, some NZCs belong to the third quantization level and some NZCs belong to the fourth quantization level, whereas the group index u=4 points to the fact that the NZCs belongs to four quantization levels. The WTRU may report the group index and the number of quantization levels using b₂ bits. The WTRU also needs to report the number of NZCs that belong to each quantization level. Such WTRU reporting for an illustrative example of g=4 quantization levels is explained as follows.

When k₁=[1], k₁=[2], k₁=[3] or k₁=[4]. The WTRU does not need to report the number of NZCs. Based on the group index u, the gNB may know that all NZCs belong to the (one) quantization level reported using b₂ bits.

When k₂=[1,2], k₂=[1,3], k₂=[1,4], k₂=[2,3], k₂=[2,4], k₂=[3,4]. The possible number of NZCs that may belong to the highest quantization level is Kᵤ^{NZ}≤K^{NZ}−1. The WTRU may report the number of NZCs that belong to the highest quantization level using b_{3,u}=┌log₂(Kᵤ^{NZ})┐ bits. Since the WTRU reported Kᵤ^{NZ} using b₃ bits, and K^{NZ} was reported using b₁ bits, the gNB can estimate the number of NZCs on the smaller quantization level.

When k₃=[1,2,3], k₃=[1,2,4], k₃=[1,3,4], k₃=[2,3,4]. The possible number of NZCs that may belong to the highest quantization level is Kᵤ^{NZ}≤K^{NZ}−2. The number of NZCs, that belong to the highest quantization level may be reported by the WTRU using b_{3,u}=┌log₂(Kᵤ^{NZ})┐ bits. The possible number of NZCs that may belong to the second highest quantization level is Kᵤ₋₁^{NZ}≤K^{NZ}−2. The number of NZCs, that belongs to the second highest quantization level may be reported by the WTRU using b_{3,u-1}=┌log₂(Kᵤ₋₁^{NZ})┐ bits. Since the WTRU may report Kᵤ^{NZ} and Kᵤ₋₁^{NZ} using b₃=b_{3,u}+b_{3,u-1} bits, and the total number of NZCs K^{NZ} was reported using b₁ bits, the WTRU may not need to report the number of NZCs on the smallest quantization level as the gNB can estimate the number of NZCs on the smaller quantization level.

When k₄=[1,2,3,4]. The possible number of NZCs that may belong to the highest quantization level is Kᵤ^{NZ}≤K^{NZ}−3. The number of NZCs, that belongs to the highest quantization level may be reported by the WTRU using b_{3,u}=┌log₂(Kᵤ^{NZ})┐ bits. The possible number of NZCs that may belong to the second highest quantization level is Kᵤ₋₁^{NZ}≤K^{NZ}−3. The number of NZCs, that belongs to the second highest quantization level may be reported by the WTRU using b_{3,u-1}=┌log₂(Kᵤ₋₁^{NZ})┐ bits. The possible number of NZCs that may belong to the third highest quantization level is Kᵤ₋₂^{NZ}≤K^{NZ}−3. The number of NZCs, that belongs to the third highest quantization level may be reported by the WTRU using b_{3,u-2}=┌log₂(Kᵤ₋₂^{NZ})┐ bits. Since the WTRU may report Kᵤ^{NZ}, Kᵤ₋₁^{NZ} and Kᵤ₋₂^{NZ} using b₃=b_{3,u}+b_{3,u-1}+b_{3,u-2} bits, and the total number of NZCs K^{NZ} was reported by the WTRU using b₁ bits, the WTRU may not need to report the number of NZCs on the smallest quantization level as the gNB can estimate the number of NZCs on the smaller quantization level.

Using the illustrative procedure, explained above, the WTRU can report the quantized subband amplitude coefficients of all K^{NZ} NZCs using a total of b=b₂+b₃ bits. Since the number of NZCs belonging to the higher quantization levels is reported first, followed by the number of NZCs belong to the second highest quantization level and so on, b₃ can be quantified as b₃=Σᵣ₌ᵤ²┌log₂(K^{NZ}−r+1)┐. In Rel. 17, b₄=3(2K^{NZ}−1) bits are used to report the quantized subband amplitude coefficients. By comparing b₄ to b₁+b₂+b₃, it can be shown that the proposed method achieves smaller feedback overhead as compared to Rel. 17, especially for higher number of NZCs.

To further reduce the feedback overhead, the WTRU may choose only to report NZCs which are related to higher quantization levels. Particularly, a threshold quantization level w, such that 1<w≤g may be used. Then, the WTRU may choose only to report NZCs with their related quantization levels higher than w. In such case, the required size of b₃ becomes, b₃=Σᵣ₌ᵤ^{w}┌log₂(K^{NZ}−r+1+h)┐, where h is the number of NZCs on all the quantization levels smaller than w. This procedure is explained above.

Following the procedure mentioned above, the WTRU reports the number of NZCs that belong to each quantization level. The WTRU also needs to report the indices of each NZCs on a beam and on the DFT vectors. In Rel. 17 a bitmap of length 2LMᵥ denoted by i_{1,7,l} is used for such indications. Three methods for the reporting NZCs indices on the L number of beams and Mᵥ number of DFT vectors are detailed above. These methods can be used for reporting beams and DFT vector indices pertaining to the NZCs.

### Applicability of the Proposed Method to Phase Coefficients Reporting

In Rel. 17, a WTRU reports a quantized subband phase coefficient using 4 bits. The proposed method for joint reporting of subband amplitude coefficients may easily find application in reporting the subband phase coefficients.

### Applicability of the Proposed Method to Wideband Amplitude Coefficients Reporting

In Rel. 17, a WTRU reports a quantized wideband amplitude coefficient using 4 bits. The proposed method for joint reporting of subband amplitude coefficients may easily find application in reporting the wideband amplitude coefficients.

### Priority Rules for the Joint Subband Amplitude Coefficients Reporting Method

Different quantized subband amplitude coefficients may be prioritized for reporting. Such prioritization can be performed based on the quantization level of a subband amplitude coefficient. The proposed method for jointly reporting the subband amplitude coefficients is used hereinafter to develop priority reporting levels. A WTRU may choose to report subband amplitude coefficients with higher quantization levels and may choose not to report subband amplitude coefficients with smaller quantization levels. Such priority rules are explained using an illustrative example of g=4 quantization levels for the quantizing subband amplitude coefficients. The same rules may be applied to other quantization levels.

For k₁: (a) When k₁=[1], which means all the subband amplitude coefficients K^{NZ} are quantized using the lowest quantization level, the WTRU may choose not to report all subband amplitude coefficients. (b) When k₁=[2], which means all the subband amplitude coefficients K^{NZ} are quantized using the second lowest quantization level, the WTRU may choose not to report all subband amplitude coefficients. (c) When k₁=[3], which means all the subband amplitude coefficients K^{NZ} are quantized using the second highest quantization level, the WTRU may choose not to report or report all subband amplitude coefficients. (d) When k₁=[4], which means all the subband amplitude coefficients K^{NZ} are quantized using the highest quantization level, the WTRU may choose to report all subband amplitude coefficients.

For k₂: (a) When k₂∈[1,2], the WTRU may choose not to report some or all amplitude coefficients pertaining to [1] and the WTRU may choose not to report some or all amplitude coefficients pertaining to [2]. (b) When k₂∈[1,3], the WTRU may choose not to report some or all amplitude coefficients pertaining to [1] and the WTRU may choose not to report some or all amplitude coefficients pertaining to [3]. (c) When k₂∈[1,4], the WTRU may choose not to report some or all amplitude coefficients pertaining to [1] and the WTRU may choose to report all amplitude coefficients pertaining to [3]. (d) When k₂∈[2,3], the WTRU may choose not to report some or all amplitude coefficients pertaining to [2] and the WTRU may choose not to report some or all amplitude coefficients pertaining to [3]. (e) When k₂∈[2,4], the WTRU may choose not to report some or all amplitude coefficients pertaining to [2] and the WTRU may choose not to report some or all amplitude coefficients pertaining to [4]. (f) When k₂∈[3,4], the WTRU may choose not to report some or all amplitude coefficients pertaining to [3] and the WTRU may choose not to report some or all amplitude coefficients pertaining to [4].

For k₃: (a) When k₃∈[1,2,3], the WTRU may choose not to report all amplitude coefficients pertaining to [1], the WTRU may choose not to report all coefficients pertaining to [2], and the WTRU may choose not to report some or all coefficients pertaining to [3]. (b) When k₃ E [1,2,4], the WTRU may choose not to report all amplitude coefficients pertaining to [1], the WTRU may choose not to report all coefficients pertaining to [2], and the WTRU may choose to report all coefficients pertaining to [4]. (c) When k₃∈[1,3,4], the WTRU may choose not to report all amplitude coefficients pertaining to [1], the WTRU may choose to report some coefficients pertaining to [3], and the WTRU may choose to report all coefficients pertaining to [4]. (d) When k₃∈[2,3,4], the WTRU may choose not to report all amplitude coefficients pertaining to [2], the WTRU may choose to report some coefficients pertaining to [3], and the WTRU may choose to report all coefficients pertaining to [3].

For k₄: (a) When k₄∈[1,2,3,4], the WTRU may choose not to report all amplitude coefficients pertaining to [1], the WTRU may choose not to report all amplitude coefficients pertaining to [2], the WTRU may choose to report some coefficients pertaining to [3], and the WTRU may choose to report all coefficients pertaining to [4].

In an example implementation, the WTRU may choose to only to report NZCs with their quantization levels higher than w to reduce feedback.

### Subband Amplitude Threshold Determination

In a first example implementation, one or more amplitude thresholds based on the quantization level of subband amplitude coefficients may be defined or used, and a WTRU may determine a subband amplitude threshold based on its related quantization level and then choose to exclude all NZCs in the CSI reporting if their related quantization level is below the threshold. The WTRU may determine two thresholds (e.g., w₁ and w₂, such that 1<w₁<w₂≤g. The WTRU may choose to exclude all NZCs whose quantization level is less than w₁. The WTRU may choose to report only x out of z number of NZCs whose quantization level lies between threshold w₁ and w₂. Threshold, w, w₁ and w₂ may be based on one or more of the following two features.

(1) A level of Doppler frequency from a measurement. One or more Doppler frequency thresholds may be used, configured, or predetermined for w, w₁ and w₂; a subband amplitude threshold(s) (SAT) may be determined if the measured Doppler frequency is within the threshold(s).

(2) A level(s) of frequency selectivity of the channel. For example, a WTRU may perform a measurement of channel frequency selectivity and the WTRU may determine a SAT based on the measured frequency selectivity. The frequency selectivity may be interchangeably used with delay spread, channel frequency coherency, and coherent bandwidth. One or more coherent bandwidth thresholds may be used, configured, or predetermined; a service area identifier (SAI) may be determined if the measured coherent bandwidth is within a threshold.

In a second example implementation, a WTRU may be explicitly indicated by a gNB which SAT to use. For example, a higher layer configuration (e.g., SIB, RRC, and/or MAC-CE) may be used to indicate SAT to use per carrier, bandwidth part (BWP), CSI reporting configuration, and/or TRP. In another example, a dynamic indication (e.g., DCI) may be used to indicate SAI.

### Subband Amplitude Threshold Indication

In an implementation, a WTRU may indicate or report a determined SAI when it is determined implicitly or autonomously. The WTRU may report SAT based on one or more of the following.

One or more uplink resources may be configured or used, and each uplink resource may be associated with a SAT.

SAI may be reported as a part of CSI. SAT may be separately encoded from its associated CSI. Therefore, a receiver may perform decoding SAI first. SAT may be jointly encoded with its associated CSI; a receiver may perform blind decoding for the SAI and its associated CSI.

### Applicability of the Proposed Method to Phase Coefficients Reporting.

The above-mentioned priority reporting rules are equally applicable to the reporting of phase coefficients.

### Reporting a Time-Series of Precoders

### Reporting a Time-Series of Precoders in Legacy Systems

The precoder structure of Rel-16/17 is given as W=W₁×W₂×W_{f}^{H}, where W₁ denotes the spatial domain basis, W₂ is the co-phasing coefficients, and W_{f} is the frequency domain compression matrix. In medium to high WTRU velocity scenario, the spatial and frequency domain basis (e.g., W₁ and W_{f}) may remain constant within a short time-period T. However, within the period T, the co-phasing coefficients (e.g., W₂) may change at a faster rate. Therefore, the precoder in medium to high WTRU velocity scenarios can be expressed as W(t)=W₁×W₂(t)×W_{f}^{H}, where t=t₁, t₂, . . . . In this context, an arising issue involves reporting a time-series of precoders (e.g., W(t) or W₂(t)) with smaller feedback overhead. Hereinafter, implementations are disclosed that report the time series of precoders W(t) and/or W₂(t) with smaller feedback overhead.

First, the elements of a Type-II CSI report may be broken down based on Rel-16 Enhanced Type-II (eType-II) codebook and Rel-17. Further enhanced Port Selection Type-II (FeType-II) codebook. These elements may be provided with a short description as follows.

TABLE 3
Elements of a Type-II CSI report with the associated
complexity in bits

| Indi- | | Feedback |
|---|---|---|
| cator | Description | overhead in bits |
| i_{1,1} | Used for DFT oversampling/beam | ┌log₂(O₁O₂)┐ |
| | scanning | |
| i_{1,2} | Used for choosing antenna indices | $⌈ {log}_{2} ( \begin{matrix}{N}_{1} {N}_{2} \\ L\end{matrix} ) ⌉$ |
| i_{1,5} | Used to determine DFT vector for | ┌log₂2M_{ν}┐ |
| | frequency domain compression | |
| i_{1,6,l} | Used to determine indices of M_{ν} DFT vectors for frequency domain compression | $⌈ {log}_{2} ( \begin{matrix}{N}_{3} - 1 \\ {M}_{v} - 1\end{matrix} ) ⌉ {N}_{3} \leq 19$ |
| i_{1,7,l} | Bitmap of length 2LM_v, whose “bit | 2LM_{ν} |
| | 1/bit 0” indicates a non-zero/zero coeffi- | |
| | cient on a certain beam and DFT vector | |
| i_{1,8,l} | Strongest coefficient indication on a | ┌log₂K^{NZ}┐ rank = 1 |
| | certain beam and DFT vector | ┌log₂2L┐ rank > 1 |
| i_{2,3,l} | Indication for one wideband amplitude | 4 |
| | coefficients | |
| i_{2,4,l} | Indication for K^{NZ} − 1 number of subband | 3(K^{NZ} −1) |
| | amplitude coefficients | |
| i_{2,5,l} | Indication for K^{NZ} − 1 number of phase | 4(K^{NZ} − 1) |
| | combining coefficients | |

The CSI elements listed in Table 3 are based on Rel-16 eType-II codebook. Rel-17 FeType-II has the same elements except i_{1,2}. In the event of high/medium WTRU velocity, the WTRU may need to report some of the above-mentioned elements with smaller periodicity. Particularly, considering the rapidly changing channel due to medium/high velocity, CSI elements related to i_{1,7,l}, i_{1,8,l}, i_{2,3,l}, i_{2,4,l}, and i_{2,5,l} may be expected to change at faster rate, which accounts for most of the feedback overhead of a Type-II CSI report. Hereinafter, methods are proposed to report the CSI elements listed in Table 2 with smaller feedback overhead.

### Reporting Differences of Precoders

### Description

The W₂ reporting constitutes a major weight of a CSI report. To report the contents of W₂ and/or W with smaller feedback overhead, a WTRU may choose to report the difference of two W₂ and/or W reports. A relative difference between two precoders at two different time instances (e.g., the current reporting interval tᵢ and the past reporting interval tⱼ) may be obtained as M_j=W(tᵢ)−W(tⱼ), where i≠j and where j=1, . . . , i−1. Similarly, the difference of the precoders at two different time instances (e.g., tᵢ and tⱼ) may also be expressed as M_j=W₂(tᵢ)−W₂ (tⱼ). At the first reporting interval (e.g., t₁), a WTRU may choose to report the contents of W₂(t₁) and/or W(t₁) in its original form. However, at a next reporting interval (e.g., tᵢ, where i>1), a WTRU may choose to report the contents of W₂(tᵢ) in its original form and/or it may choose to report a difference of W₂(tᵢ) and W₂(tⱼ). A WTRU may determine the type of W₂ and/or W reporting based on the following.

### Reporting Type Determination

Let M(tᵢ) and M(tⱼ) be vectors of non-zero quantized subband amplitude coefficients i_{2,4,l}, and/or both wideband amplitude coefficients i_{2,3,l}, and/or phase coefficients i_{2,5,l} of W₂(tᵢ) and W₂ (tⱼ), respectively. Vectors M(tᵢ) and M(tⱼ) may also represent the non-zero coefficients of W(tᵢ) and W(tⱼ), respectively. The quantized non-zero coefficients of M(t₁) is assumed to be reported by the WTRU at reporting interval t_1 and now the WTRU wishes to report M(tᵢ) at reporting interval t_i.

Each non-zero coefficient of M(tᵢ) and M(tⱼ) are quantized with the same number of bits (e.g., γ or different number of bits (e.g., γᵢ and γⱼ)). A WTRU may report the contents of M(tᵢ) in its original form or it may choose to report the resulting non-zero coefficients after the Mⱼ=M(tᵢ)−M(tⱼ) operation. A WTRU may determine whether to report M(tᵢ) in its original form or to report Mⱼ based on the following.

At a reporting interval i (e.g., tᵢ) a WTRU may find Mⱼ=M(tᵢ)−M(tⱼ) for all j=1, . . . , i−1. Then, the WTRU may determine the number of non-zero coefficients in Mⱼ (e.g., K_{d}^{NZ}(tⱼ) for all j). Then, the WTRU may obtain the index j that satisfies

$${arg min}_{∀ j} {K}_{d}^{N Z} ( {t}_{j} ) .$$

Since j=1, . . . , i−1, a chosen index j can be reported using ┌log₂(i−1)┐ bits. Therefore, if γK_{d}^{NZ}(tⱼ)+┌log₂(i−1)┐<γK^{NZ}(tᵢ), where K^{NZ}(tᵢ) is the number of non-zero coefficients in W₂(tᵢ), the WTRU can report the index j and the non-zero outcomes of Mⱼ. On the other hand, when γK_{d}^{NZ}(tⱼ)+┌log₂(i−1)┐≥γK^{NZ}(tᵢ), the WTRU may choose to report the K^{NZ}(tᵢ) number of non-zero amplitude/phase coefficients.

### Reporting Type Indication

In each reporting interval, based on the above-mentioned inequalities, a WTRU may choose to report a difference of the non-zero subband amplitude coefficients and/or phase coefficients or it may choose to report the non-zero subband amplitude coefficients and phase coefficients in its original form. Particularly, in each reporting interval, a WTRU may choose to report both the non-zero subband amplitude coefficients and phase coefficients in its original form, or a WTRU may choose to report the subband amplitude coefficients in its original form and a difference of the non-zero phase coefficients (e.g., Mⱼ), or a WTRU may choose to report phase coefficient in its original form and a difference of the subband amplitude coefficients (i.e., Mⱼ) or a WTRU may choose to report a difference of both subband amplitude coefficient and phase coefficient. A WTRU may indicate the type of reporting using two bits in UCI. A WTRU may explicitly indicate, to a gNB, which reporting type to use. For example, a WTRU may indicate a reporting mode to use per carrier, BWP, CSI reporting configuration, and/or TRP. In an alternate solution, a WTRU may separately report the reporting type for amplitude coefficients using one bit in the UCI based on the determined reporting type. A WTRU may also separately report the reporting type for phase coefficients using one bit in the UCI based on the determined reporting type.

Periodic Reporting of W₁ and W_{f} with Multiple and Aperiodic Reporting of W₂

Due to the fast-changing wireless channel at medium/high velocities, certain parameters of the channel change much faster than others. For instance, the channel gains and phases change at a higher rate compared to path-loss and shadowing. More explicitly, the spatial domain (SD) bases W₁ and the frequency domain (FD) bases W_{f} of the channel change at a much smaller rate compared to the co-phasing coefficients W₂. Therefore, it makes sense to report W₂ at a faster rate compared to a rate for reporting W₁ and W_{f}.

In an implementation, for each layer, periodic reporting of W₁ and W_{f} and aperiodic reporting of W₂ may be performed. More explicitly, in an implementation, a CSI report with payload size x₁ may be periodically defined with period t₁ to report W₁, W₂, and W_{f}. The CSI report may also be used to report only W₁ and W_{f}, in which case the payload size of the CSI report can be g₁ with g₁<x₁. The period t₁ may be defined as a function of Doppler and/or Doppler threshold(s) and/or change in the transmission of TRS. For each period t₁, N number of CSI reports each with payload size yₙ, n=1, . . . , N, where yₙ≤g₁<x₁ may be defined to report multiple W₂ co-phasing coefficients matrices. The payload yₙ of each CSI report may be defined as a function of Doppler or threshold of Doppler(s) and/or its correlation with a past CSI report. The number of W₂ coefficient matrices to be reported for fixed W₁ and W_{f} may be performed using N reports, where each report may be aperiodically trigged and where the periodicity between two reports can be defined as a function of Doppler or Doppler threshold(s) and/or its correlation with a past report. Also, the number of CSI reports N and the periodicity between two reports may be defined as a function of Doppler and/or Doppler threshold or correlation with past report.

In an implementation, when reporting the N number of periodic reports for fixed W₁ and W_{f}, a WTRU may report one, more, or different combinations of the CSI elements indicated by i_{1,7,l}, i_{1,8,l}, i_{2,3,l}, i_{2,4,l}, and i_{2,5,l}. More explicitly, a WTRU may only report pₕ≤K^{NZ}−1 number of i_{2,5,l} phase coefficients per layer for 1≤n≤N number of W₂ reports.

A WTRU may only report 0≤pₕ≤K^{NZ}−1 number of i_{2,5,l} phase coefficients per layer per report for 1≤n≤N number of aperiodic W₂ reports. A WTRU may also report 0≤pₕ≤K^{NZ}−1 number of i_{2,5,l} phase coefficients per layer per report for 1≤ [symbol] ≤N number of W₂ reports along with 0≤rₚ<N number of complex scaling vector [symbol] ∈C^{1×δ}^{ₚ}, where 1≤δₚ≤K^{NZ}−1 for predicting phase coefficients for future reports.

A WTRU may only report 0≤Aₕ≤K^{NZ}−1 number of i_{2,4,l} subband amplitude coefficients per layer per report for 1≤ [symbol] ≤N number of W₂ reports. A WTRU may also report 0≤Aₕ≤K^{NZ}−1 number of i_{2,4,l} subband amplitude coefficients per layer per report for 1≤ [symbol] ≤N number of W₂ reports along with 0≤rₕ<N number of complex vectors [symbol] ∈C^{1×δ}^{ₐ}, where 1≤δₐ≤K^{NZ}−1, for predicting phase coefficients for future reports.

A WTRU may only report bitmap i_{1,7,l} per layer for 1≤ [symbol] ≤N number of reports out of the total reports. When a WTRU chooses only to report 0≤Aₕ≤K^{NZ}−1 number of i_{2,4,l subband amplitude coefficients per layer for} 1≤ [symbol] ≤N number of W₂ reports, the WTRU may also report i_{1,7,l} only for the associated 1≤ [symbol] ≤N number of reports used for reporting 0≤Aₕ≤K^{NZ}−1 number of i_{2,4,l} per layer.

A WTRU may only report wₕ≤2 number of i_{2,3,l} wideband amplitude coefficients per layer per report for 1≤ [symbol] ≤N number of W₂ reports. A WTRU may also report 0≤Aₕ≤K^{NZ}−1 number of i_{2,4,l} subband amplitude coefficients per layer for 1≤ [symbol] ≤N number of W₂ reports along with 0≤r_{w}≤N number of complex vectors [symbol] ∈C^{1×δ}^{_{w}}, where 1≤δ_{w}≤2 for predicting wideband amplitude coefficients for future reports.

A WTRU may only report 0≤s≤1 number of strongest coefficients per layer per report only for 1≤ [symbol] ≤N number of W₂ reports. A WTRU may report the strongest coefficient by reporting its quantized value and/or beam index and/or DFT vector index. A WTRU may provide an indication as part of a time-differenced carrier phase (TDCP) report that the strongest coefficient has common beam and DFT vector indices for 1≤ [symbol] ≤N number of reports.

A WTRU may include indications for pₕ and/or n and/or δₚ and/or Aₕ and/or [symbol] and/or rₕ and/or δₐ and/or rₚ and/or [symbol] and/or [symbol] and/or wₕ and/or [symbol] and/or δ_{w} and/or s and/or [symbol] measured by TRS and/or CSI-RS as part of a TDCP report.

### Strongest Beam Reporting

### Reporting Strongest Beam in Legacy Systems

Rel-15, Type-II/Type-II Port Selection codebook: In Rel-15, the wideband amplitude coefficient, subband amplitude coefficient, and the related phase coefficient on the strongest beam are denoted by k_{l,i}_{_{1,3,l}}⁽¹⁾, k_{l,i}_{_{1,3,l}}⁽²⁾ and c_{l,i}_{_{1,3,l}}, respectively, where i_{1,3,l}∈{0,1, . . . , 2L}. In Rel-15, each wideband amplitude coefficient k_{l,i}⁽¹⁾ is quantized using three bits, each subband amplitude coefficient k_{l,i}⁽²⁾ is quantized using one bit, and each phase coefficient c_{l,i} can be quantized using log₂ N_{PSK} bits, where N_{PsK}∈{4,8}. Reporting amplitude and phase coefficients of each beam requires six bits per layer when N_{PsK}=4, and seven bits per layer when N_{PSK}=8. Moreover, in Rel-15, L∈{2, 3, 4} beams per layer are supported. In Rel-15, for each layer, the WTRU reports the index of the strongest beam i_{1,3,l} using ┌log₂ 2L┐ bits. Then, the gNB assumes k_{l,i}_{_{1,3,l}}⁽¹⁾=7, k_{l,i}_{_{1,3,l}}⁽²⁾=1, and c_{l,i}_{_{1,3,l}}=0. For L=2, this results in feedback overhead reduction of four bits per layer when N_{PSK}=4 and five bits per layer when N_{PSK}=8. For L=3 and L=4, this results in feedback overhead reduction of three bits per layer when N_{PSK}=4 and four bits per layer when N_{PSK}=8.

Rel-16 Enhanced Type-II/Enhanced Type-II Port Selection Codebook: In Rel-16, the strongest wideband amplitude coefficient is denoted by k_{l,└i}_{ₗ}_{*/L┘}⁽¹⁾ and the strongest subband amplitude coefficient is k_{l,i}_{ₗ}_{*,f}_{ₗ}_{*}⁽²⁾, where iₗ*∈{0,1, . . . , 2L} and fₗ*∈{0,1, . . . , Mᵥ−1} are the beam and DFT vector indices pertaining to the strongest wideband and subband amplitude coefficients, respectively, and where Mᵥ is the total number of DFT vectors for frequency domain compression. The phase coefficient pertaining to the strongest wideband and subband amplitude coefficients is denoted by c_{l,i}_{ₗ}_{*,f}_{ₗ}_{*}. In Rel-16, each wideband amplitude coefficient k_{l,i}⁽¹⁾ is quantized using four bits, each subband amplitude coefficient k_{l,i}⁽²⁾ is quantized using three bits, and each phase coefficient c_{l,i,f} is quantized using four bits. Thus, each beam requires eleven bits for reporting the amplitude and phase coefficient values and L∈{2, 4, 6} number of beams per layer are supported. In Rel-16, the WTRU does not report the quantized amplitude and phase coefficient values of the strongest beam. Instead, the WTRU may first remap the codebook indices in such a way that, after remapping, the index of the strongest amplitude coefficient is fₗ*=0, ∀l. For example, instead of reporting the quantized coefficient values (i.e., k_{l,└i}_{ₗ}_{*/L┘}⁽¹⁾ and k_{l,i}_{ₗ}_{*,f}_{ₗ}_{*}⁽²⁾), the WTRU may only report the strongest beam index (i.e., iₗ*) using ┌log₂ 2L┐ bits. Then, the gNB may assume k_{l,└i}_{ₗ}_{*/L┘}⁽¹⁾=15, k_{l,i}_{ₗ}_{*,0}⁽²⁾=7, and c_{l,i}_{ₗ}_{*,0}=0. This procedure results in feedback overhead reduction of nine bits per layer when L=2, eight bits per layer when L=4 and seven bits per layer when L=6. The reduction in feedback overhead comes at the cost of WTRU complexity in terms of remapping the codebook indices to ensure fₗ*=0. Particularly, for multiple reporting of W_2 for fixed W_1 and W_f this procedure may impose a huge burden of remapping complexity on the WTRU.

Rel-17 Further Enhanced Type-II Port Selection Codebook: In Rel-17, like Rel-16, each wideband amplitude coefficient denoted by k_{l,i}⁽¹⁾ is quantized using four bits, each subband amplitude coefficient denoted by k_{l,i}⁽²⁾ is quantized using three bits, and each phase coefficient c_{l,i,f} is quantized using four bits. The chosen number of antenna ports is K₁=αP_{CSI-RS}, where P_{CSI-RS} is the given number of antenna ports, L=K₁/2 is the number of beams, M and a are frequency domain compression parameters and the index of the strongest beam on some layer is i*∈0,1, . . . , K₁−1. In Rel-17, the quantized value of the strongest coefficients k_{l,└i}_{ₗ}_{*/L┘}⁽¹⁾, k_{l,i}_{ₗ}_{*,f}_{ₗ}_{*}⁽²⁾ and the related c_{l,i}_{ₗ}_{*,f}_{ₗ}_{*} is not reported. Instead, only the index iₗ* is reported using ┌log₂ K₁┐ bits after the WTRU remaps the codebook indices such that the index of the strongest amplitude coefficient is fₗ*=0, ∀l. When observing Table 3, it can be concluded that the strongest beam index reporting results in feedback overhead reduction of up to 9 bits.

### Issues Related to Strongest Beam Index Reporting

In Rel-16/17, to report the strongest beam, the gNB needs to know the beam index iₗ* and the DFT vector index fₗ*. The WTRU only reports iₗ*. To avoid reporting fₗ*, the WTRU remaps the codebook indices in such a way that the fₗ*=0. This remapping results in feedback overhead reduction but at the expense of WTRU complexity. Rel-18 MIMO work aims to enhance CSI for high/medium WTRU velocities, where multiple W₂ are reported for fixed W₁ and W_{f}. In this case, the WTRU will need to remap the codebook indices several times for fixed W₁ and W_{f}, which imposes a huge computational burden on WTRU.

### Strongest Coefficients Reporting

In a solution that enables a WTRU to avoid the computational complexity of remapping the codebook indices when reporting the strongest coefficient, on each layer l, a WTRU may perform one or more of the following five actions.

(1) A WTRU may not remap the codebook indices and/or the DFT vector indices for ensuring fₗ*=0; (2) A WTRU may not report the strongest beam index (iₗ*) and/or the associated DFT vector index (fₗ*); (3) A WTRU may not report amplitude coefficient k_{l,└i}_{ₗ}_{*/L┘}⁽¹⁾; (4) A WTRU may not report phase combining coefficient c_{l,i}_{ₗ}_{*,f}_{ₗ}_{*}; and/or (5) A WTRU may report the quantized value of the subband amplitude coefficient k_{l,i}_{ₗ}_{*,f}_{ₗ}_{*}⁽²⁾.

By observing the reported quantized subband amplitude coefficient on layer l (e.g., k_{l,i,f}⁽²⁾) the beam index with the strongest coefficient iₗ* and the DFT vector index with the strongest coefficient fₗ* may be obtained according to (1):

$$[ {i}_{l}^{*} , {f}_{l}^{*} ] = {arg max}_{∀ i , f} ( {k}_{l , i , f}^{( 2 )} ) \qquad ( 1 )$$

Since the reported subband amplitude coefficients k_{l,i,f}⁽²⁾ ∀i, f are quantized, there might be multiple combinations of i, f which satisfy (1). In such a case, min(iₗ*) and min(fₗ*), and/or max(iₗ*) and max(fₗ*), and/or the second max(iₗ*) and the second max(fₗ*), and/or the third max(iₗ*) and the third max(fₗ*), and so on may be classified as the beam and DFT vector indices with the strongest amplitude coefficient.

In an alternate solution that enables a WTRU to avoid the computational complexity of remapping the codebook indices when reporting the strongest coefficient, on each layer l, a WTRU may perform one or more of the following six actions. (1) A WTRU may not remap the codebook indices and/or the DFT vector indices for ensuring fₗ*=0; (2) A WTRU may not report the strongest beam index (iₗ*) and/or the associated DFT vector index (fₗ*); (3) A WTRU may not report a phase combining coefficient c_{l,i}_{ₗ}_{*,f}_{ₗ}_{*}; (4) A WTRU may not report the quantized value of the subband amplitude coefficient k_{l,i}_{ₗ}_{*,f}_{ₗ}_{*}⁽²⁾; (5) A WTRU may report the wideband amplitude coefficient k_{l,└i}_{ₗ}_{*/L┘}⁽¹⁾; and/or (6) A WTRU may report an index of the DFT vector pertaining to max(k_{l,i,f}⁽²⁾), ∀i, f.

By observing the reported, quantized, wideband amplitude coefficient on layer l (e.g., k_{l,└i}_{ₗ}_{*/L┘}⁽¹⁾), the beam index with the strongest coefficient iₗ* may be obtained according to:

$${i}_{l}^{*} = {arg max}_{∀ i} ∀ i ( {k}_{l , ⌊ i / L ⌋}^{( 1 )} ) \qquad ( 2 )$$

In an alternative implementation that enables a WTRU to avoid the computational complexity of remapping the codebook indices when reporting the strongest coefficient, on each layer l, a WTRU may perform one or more of the following six actions. (1) A WTRU may not remap the codebook indices and/or the DFT vector indices for ensuring fₗ*=0; (2) A WTRU may report the strongest beam index iₗ*; (3) A WTRU may report the associated DFT vector index fₗ*; (4) A WTRU may not report amplitude coefficient k_{l,└i}_{ₗ}_{*/L┘}⁽¹⁾; (5) A WTRU may not report phase combining coefficient c_{l,i}_{ₗ}_{*,f}_{ₗ}_{*}; and/or (6) A WTRU may not report the quantized value of the subband amplitude coefficient k_{l,i}_{ₗ}_{*,f}_{ₗ}_{*}⁽²⁾.

Upon receiving the indices iₗ* and fₗ* at the gNB, the wideband amplitude coefficient k_{l,└i}_{ₗ}_{*/L┘}⁽¹⁾ may be set to the maximum value. Similarly, the subband amplitude coefficient k_{l,i}_{ₗ}_{*,f}_{ₗ}_{*}⁽²⁾ may be set to the maximum value. Finally, the phase combining coefficient c_{l,i}_{ₗ}_{*,f}_{ₗ}_{*} may be set to zero.

In one embodiment, a method implemented in WTRU includes sampling a wireless channel at a rate employed to capture a Doppler effect on the wireless channel. The WTRU measures CSI of the wireless channel based on at least one configured channel state information reference signal (CSI-RS).

The WTRU estimates based on the captured Doppler effect, a trend of channel variation. A correction to the CSI of the wireless channel is made by the WTRU based on the estimated trend of channel variation. The WTRU then transmits a CSI measurement report based on the corrected CSI of the wireless channel.

In one embodiment, a method performed by a WTRU to reduce overhead in reporting precoding matrices includes receiving a configuration for CSI reporting to a BS. The configuration includes a number of matrices to report to the BS, each matrix including an indication of non-zero coefficients (NZC)s occurring in an arrangement of columns and rows.

The WTRU receives one or more CSI-RS used to measure a channel for CSI reporting and determines an indication of NZCs for each matrix based on the channel measurements.

The WTRU reports the indication of NZCs to the BS for each matrix using indicators for each of the NZCs occurring in the columns and rows of each matrix, wherein a report for each column in a matrix includes: (a) an indication of a total number of NZCs in a respective column of the matrix, and (b) an indication of the row in the respective column where the NZCs occur. In the method, all columns in a matrix with at least one NZC and with a number of NZCs less than the number of rows are reported, and all NZC occurrences are reported to the BS for each matrix of the number of matrices.

In one embodiment, a method performed by a WTRU to reduce overhead in reporting precoding matrices includes receiving a configuration for CSI reporting to a BS. The configuration includes a number of matrices to report to the BS, each matrix including an indication of non-zero coefficients (NZC)s occurring in an arrangement of rows and columns.

The WTRU receives one or more CSI-RS used to measure a channel for CSI reporting and determines an indication of NZCs for each matrix based on the channel measurements.

The WTRU reports the indication of NZCs to the BS for each matrix using indicators for each of the NZCs occurring in the rows and columns of each matrix, wherein a report for each row in a matrix includes: (a) an indication of a total number of NZCs in a respective row of the matrix, and (b) an indication of the column in the respective row where the NZCs occur. In the method, all rows in a matrix with at least one NZC and with a number of NZCs less than the number of columns are reported, and all NZC occurrences are reported to the BS for each matrix of the number of matrices.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UL”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.) and/or “permissive” terms (e.g., the term “is” and/or the term “are” may be interpreted as “may” and/or “might”, the terms “refer(s)” may be interpreted as “may refer” and/or “might refer”, the terms “receive(s)” may be interpreted as “may receive” and/or “might receive”, the terms “support(s)” may be interpreted as “may support” and/or “might support”, the terms “interface(s)” may be interpreted as “may interface” and/or “might interface”, the terms “transmit(s)” may be interpreted as “may interface” and/or “might interface”, “may transmit” and/or “might transmit”, the terms “send(s)” may be interpreted as “may send” and/or “might send”, the terms “does not refer” (and/or the like) may be interpreted as “may not refer” and/or “might not refer”, the terms “does not receive” (and/or the like) may be interpreted as “may not receive” and/or “might not receive”, the terms “does not support” (and/or the like) may be interpreted as “may not support” and/or “might not support”, the terms “does not interface” (and/or the like) may be interpreted as “may not interface” and/or “might not interface”, the terms “does not transmit” (and/or the like) may be interpreted as “may not transmit” and/or “might not transmit”, the terms “does not send” (and/or the like) may be interpreted as “may not send” and/or “might not send”, etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

What is claimed is:

1-20. (canceled)

21. A wireless transmit/receive unit (WTRU) comprising a processor and a transceiver, the processor configured to:
receive, via the transceiver, channel state information (CSI) reporting configuration information, the configuration information indicating (i) a plurality of matrices, (ii) for each of the plurality of matrices, a total number of rows and columns, and (iii) an indication to report on non-zero coefficients (NZCs);
receive, via the transceiver, one or more CSI reference signals (CSI-RS);
determine a precoding matrix indicator (PMI) based on channel measurements associated with the one or more CSI-RS, wherein the PMI comprises, for each matrix of the plurality of matrices:
(a) an indication whether each column of the matrix includes at least one NZC; and
(b) an indication of one or more row indices that have a NZC for each column of the matrix that includes at least one NZC; and
report, via the transceiver, the PMI.

22. The WTRU of claim 21, wherein the indication whether each column of the matrix includes at least one NZC comprises an indication of a total number of NZCs for the column.

23. The WTRU of claim 21, wherein the processor is configured to determine indications of NZCs per column and per row to determine the PMI, wherein each determined indication of the determined indications is either zero or one.

24. The WTRU of claim 23, wherein the indications in a row correspond to a polarization of a beam and the indications in a column correspond to a discrete Fourier transform (DFT) vector.

25. The WTRU of claim 21, wherein the processor is configured to send, via the transceiver, coefficients for each row index that has a NZC indicated in the PMI.

26. The WTRU of claim 21, wherein the reported PMI lacks NZC values for any column having all zero coefficient indicators.

27. The WTRU of claim 21, wherein the indication of the one or more indices for each column comprises an identification or location indication of a row in a column that has a NZC value.

28. A method performed by wireless transmit/receive unit (WTRU), the method comprising:
receiving channel state information (CSI) reporting configuration information, the configuration information indicating (i) a plurality of matrices, (ii) for each of the plurality of matrices, a total number of rows and columns, and (iii) an indication to report on non-zero coefficients (NZCs);
receiving one or more CSI reference signals (CSI-RS);
determining a precoding matrix indicator (PMI) based on channel measurements associated with the one or more CSI-RS, wherein the PMI comprises, for each matrix of the plurality of matrices:
(a) an indication whether each column of the matrix includes at least one NZC; and
(b) an indication of one or more row indices that have a NZC for each column of the matrix that includes at least one NZC; and
reporting the PMI.

29. The method of claim 28, wherein the indication whether each column of the matrix includes at least one NZC comprises an indication of a total number of NZCs for the column.

30. The method of claim 28, further comprising determining indications of NZCs per column and per row to determine the PMI, wherein each determined indication of the determined indications is either zero or one.

31. The method of claim 30, wherein the indications in a row correspond to a polarization of a beam and the indications in a column correspond to a discrete Fourier transform (DFT) vector.

32. The method of claim 28, further comprising sending coefficients for each row index that has a NZC indicated in the PMI.

33. The method of claim 28, wherein the reported PMI lacks NZC values for any column having all zero coefficient indicators.

34. The method of claim 28, wherein the indication of the one or more indices for each column comprises an identification or location indication of a row in a column that has a NZC value.

35. A wireless transmit/receive unit (WTRU) comprising a processor and a transceiver, the processor configured to:
receive, via the transceiver, channel state information (CSI) reporting configuration information, the configuration information indicating (i) a plurality of matrices, (ii) for each of the plurality of matrices, a total number of rows and columns, and (iii) an indication to report on non-zero coefficients (NZCs);
receive, via the transceiver, one or more CSI reference signals (CSI-RS);
determine a precoding matrix indicator (PMI) based on channel measurements associated with the one or more CSI-RS, wherein the PMI comprises, for each matrix of the plurality of matrices:
(a) an indication whether each row of the matrix includes at least one NZC; and
(b) an indication of one or more column indices that have a NZC for each row of the matrix that includes at least one NZC; and
report, via the transceiver, the PMI.

36. The WTRU of claim 35, wherein the indication whether each row of the matrix includes at least one NZC comprises an indication of a total number of NZCs for the row.

37. The WTRU of claim 35, wherein the processor is configured to determine indications of NZCs per column and per row to determine the PMI, wherein each determined indication of the determined indications is either zero or one.

38. The WTRU of claim 37, wherein the indications in a column correspond to a polarization of a beam and the indications in a row correspond to a discrete Fourier transform (DFT) vector.

39. The WTRU of claim 35, wherein the processor is configured to send, via the transceiver, coefficients for each column index that has a NZC indicated in the PMI.

40. The WTRU of claim 35, wherein the reported PMI lacks NZC values for any row having all zero coefficient indicators.
